(19) United States
(12) Patent Application Publication
(10) Pub. No.: US 2019/0236844 A1
(43) Pub. Date: Aug. 1, 2019

(54) AUGMENTED REALITY SYSTEM

(71) Applicant: ISG CENTRAL SERVICES LIMITED, London (GB)

(72) Inventors: Andrei BALASIAN, London (GB); Toby Stanley SORTAIN, South Bromley (GB)

(73) Assignee: ISG CENTRAL SERVICES LIMITED, London (GB)

(21) Appl. No.: 16/265,162

(22) Filed: Feb. 1, 2019

Related U.S. Application Data
(60) Provisional application No. 62/625,211, filed on Feb. 1, 2018.

(51) Int. Cl. G06T 19/00; G06T 11/60

(52) U.S. Cl. CPC G06T 19/006; G06T 2200/24; G06T 2219/004; G06T 11/60

(57) ABSTRACT

An improved augmented reality system utilizes locational awareness in accurately conveying equipment related information to users throughout the construction, occupation, and facilities management phases. In one embodiment the system may generate an image via a digital camera, retrieve positional information corresponding to the generated image from a positional information sensor, retrieve augmented data associated with an object depicted in the generated image based on the retrieved positional information, modify the generated image to represent the augmented data within the image, transmit the modified image, using a communication module, to at least one server, and cause the system to present one or more of the generated image and the modified image using the display. In one embodiment, augmented data is at least one of operational data, schematic data, training data, and maintenance data. The augmented data may correspond to a hazard or a snag.

### CROSS-REFERENCE TO RELATED APPLICATIONS

This application claims the benefit of U.S. Provisional Application No. 62/625,211 filed Feb. 1, 2018, the contents of which are hereby incorporated by reference.

### TECHNICAL FIELD

The present disclosure is directed towards an improved augmented reality system. In one embodiment, the augmented reality system may be used in connection with facilities management and/or construction.

### BACKGROUND

In facilities management and construction industries there is an information gap between the construction and occupation phases. For example, information regarding building equipment and installation that is critical in the construction phase may not be accurately conveyed to users, maintenance personnel, and engineers in the occupation and facilities management phase. Accordingly, there is a need to view and access data and information related to building equipment and installation during the occupation and facilities management phase. The conveyance of information related to equipment and installation is further complicated by the inaccessibility of the equipment in question. For example, in conventional environments it is impossible to view the devices and objects that may be located within a visually obstructed area such as a suspended ceiling or wall. Accordingly, there remains a need to be able to provide information related to equipment that may be located in inaccessible environments.

### SUMMARY

In one embodiment, a system built in accordance with the present disclosure includes a processor, a user interface coupled to the processor and having a display, a positional information sensor coupled to the processor, a communication module coupled to the processor, a digital camera coupled to the processor, and non-transitory memory coupled to the processor. The non-transitory memory may store instructions that, when executed by the processor, cause the system to generate an image via the digital camera, retrieve positional information corresponding to the generated image from the positional information sensor, retrieve augmented data associated with an object depicted in the generated image based on the retrieved positional information, modify the generated image to represent the augmented data within the image, transmit the modified image, using the communication module, to at least one server, and cause the system to present one or more of the generated image and the modified image using the display. In one embodiment, augmented data is at least one of operational data, schematic data, training data, and maintenance data. The augmented data may correspond to a hazard or a snag.

In one embodiment, the non-transitory memory coupled to the processor may store further instructions that, when executed by the processor, cause the system to exhibit on the display of the user interface, an application configured to receive object information and positional information for an object, generate augmented data associated with the object in accordance with the received object information and received positional information, and store the augmented data on a database communicatively coupled to the at least one server.

In one embodiment, a system built in accordance with the present disclosure includes a processor, a user interface coupled to the processor and including a display, a positional information sensor coupled to the processor, a communication module coupled to the processor; and non-transitory memory coupled to the processor. The non-transitory memory may store instructions that, when executed by the processor, cause the system to retrieve a two-dimensional representation of an environment, retrieve positional information from the positional information sensor, modify the two-dimensional representation of the environment with the positional information, transmit the modified two-dimensional representation of the environment, using the communication module, to a server, and cause the system to present one or more generated images including the modified two-dimensional representation of the environment using the display.

In one embodiment, a system built in accordance with the present disclosure includes a first computing device having an application configured to retrieve a two-dimensional representation of an environment, a database communicatively coupled to the first computing device via a network, the first computing device further configured to store equipment data on the database, and at least one server having at least one processor and non-transitory memory, the non-transitory memory storing processor executable instructions. The execution of the processor executable instructions by the at least one processor causing the at least one server to receive from the first device the two-dimensional representation of an environment, store the two-dimensional representation of the environment on the database, retrieve, from a user device having a display and a camera, one or more images corresponding to the environment, generate a three-dimensional representation of the environment based on the one or more images retrieved from the user device and the two-dimensional representation of the environment, and exhibit on the display of the user device the three-dimensional representation of the environment.

In some embodiments, a system includes a processor, a user interface coupled to the processor and including a display, a positional information sensor coupled to the processor, a communication module coupled to the processor, a digital camera coupled to the processor, and non-transitory memory coupled to the processor and storing instructions that, when executed by the processor, cause the system to: generate an image via the digital camera, retrieve positional information corresponding to the generated image from the positional information sensor, retrieve augmented data associated with an object depicted in the generated image based on the retrieved positional information, modify the generated image to represent the augmented data within the image, transmit the modified image, using the communication module, to at least one server, and cause the system to present one or more of the generated image and the modified image using the display.

In some embodiments, the augmented data is at least one of operational data, schematic data, training data, and maintenance data. The training data may include one or more of instructions for operating the object depicted in the generated image and electronic links to electronic training videos for the object depicted in the generated image. The augmented data corresponds to a hazard or a snag. Further, the system may exhibit on the display of the user interface, an application configured to receive object information and positional information for an object, generate augmented data associated with the object in accordance with the received object information and received positional information, and store the augmented data on a database communicatively coupled to the at least one server.

In some embodiments the system includes a processor, a user interface coupled to the processor and including a display, a positional information sensor coupled to the processor, a communication module coupled to the processor, and non-transitory memory coupled to the processor and storing instructions that, when executed by the processor, cause the system to: retrieve a multi-dimensional representation of an environment, retrieve positional information from the positional information sensor, modify the multi-dimensional representation of the environment with the positional information, transmit the modified multi-dimensional representation of the environment, using the communication module, to a server, and cause the system to present one or more generated images including the modified multi-dimensional representation of the environment using the display.

In some embodiments, the multi-dimensional representation is one of a two-dimensional representation, and a three-dimensional representation. In some embodiments, the processor causes the system to modify the modified multi-dimensional representation of the environment with augmented data. The augmented data is at least one of operational data, schematic data, training data, and maintenance data. The training data includes one or more of instructions for operating the object depicted in the generated image and electronic links to electronic training videos for the object depicted in the generated image. The augmented data corresponds to a hazard or a snag.

In some embodiments, a method includes obtaining an image of an environment, retrieving positional information corresponding to the generated image from a positional information sensor of a user computing device located within the environment, retrieving augmented data associated with an objected depicted in the generated image based on the retrieved positional information, modifying the generated image to represent the augmented data within the image, and transmitting the modified image to a server configured to display, on the user computing device, the modified image. Obtaining an image of the environment may include generating an image via a digital camera of a user computing device. Obtaining an image of the environment may include retrieving a multi-dimensional representation of the environment. Augmented data is at least one of operational data, schematic data, training data, and maintenance data. Training data includes one or more of instructions for operating the object depicted in the generated image and electronic links to electronic training videos for the object depicted in the generated image. Augmented data may correspond to a hazard or a snag. The method may include exhibiting on the display of a user interface of the user computing device, an application configured to receive object information and positional information for an object. The method may also include generating augmented data associated with the object in accordance with the received object information and received positional information, and storing the augmented data on a database communicatively coupled to the server. The step of retrieving positional information may include obtaining an image of a marker within the environment, and determining the position of the user computing device in relation to the position of the marker within the environment, wherein the position of the marker within the environment is stored in a digital model of the environment.

### BRIEF DESCRIPTION OF THE DRAWINGS

FIG. 1 illustrates a functional block diagram for a system built in accordance with an aspect of the present disclosure.

FIG. 2 illustrates a diagram of a computing device in accordance with an aspect of the present disclosure.

FIG. 3 illustrates a flow chart for a method providing augmented reality functionality in accordance with an aspect of the present disclosure.

FIG. 4A illustrates a flow chart for a method related to a 2D floor plan with locational awareness in connection with augmented reality functionality and in accordance with an aspect of the present disclosure.

FIG. 4B illustrates a flow chart for a method related to a 2D floor plan with locational awareness in connection with augmented reality functionality and in accordance with an aspect of the present disclosure.

FIG. 5A illustrates a flow chart for a method related to a 2D floor plan with locational awareness in connection with augmented reality functionality and in accordance with an aspect of the present disclosure.

FIG. 5B illustrates a flow chart for a method related to a 2D floor plan with locational awareness in connection with augmented reality functionality and in accordance with an aspect of the present disclosure.

FIG. 5C illustrates a flow chart for a method related to a 2D floor plan with locational awareness in connection with augmented reality functionality and in accordance with an aspect of the present disclosure.

FIG. 6 illustrates an example 2D floor plan with locational awareness in accordance with an aspect of the present disclosure.

FIG. 7 illustrates an example 2D floor plan with locational awareness in accordance with an aspect of the present disclosure.

FIG. 8A illustrates a flow chart for a method related to an operation and maintenance manual with locational awareness in connection with augmented reality functionality and in accordance with an aspect of the present disclosure.

FIG. 8B illustrates a flow chart for a method related to an operation and maintenance manual with locational awareness in connection with augmented reality functionality and in accordance with an aspect of the present disclosure.

FIG. 9 illustrates an example operation and maintenance manual with locational awareness in accordance with an aspect of the present disclosure.

FIG. 10A illustrates a flow chart for a method related to a training application with locational awareness in connection with augmented reality functionality and in accordance with an aspect of the present disclosure.

FIG. 10B illustrates a flow chart for a method related to a training application with locational awareness in connection with augmented reality functionality and in accordance with an aspect of the present disclosure.

FIG. 11 illustrates an example training application with locational awareness in accordance with an aspect of the present disclosure.

FIG. 12A illustrates a flow chart for a method related to an operation and maintenance manual with locational awareness in connection with augmented reality functionality and in accordance with an aspect of the present disclosure.

FIG. 12B illustrates a flow chart for a method related to an operation and maintenance manual with locational awareness in connection with augmented reality functionality and in accordance with an aspect of the present disclosure.

FIG. 13A illustrates a flow chart for a method related to a 3D augmented reality model with locational awareness in accordance with an aspect of the present disclosure.

FIG. 13B illustrates a flow chart for a method related to a 3D augmented reality model with locational awareness in accordance with an aspect of the present disclosure.

FIG. 13C illustrates a flow chart for a method related to a 3D augmented reality model with locational awareness in accordance with an aspect of the present disclosure.

FIG. 13D illustrates a flow chart for a method related to a 3D augmented reality model with locational awareness in accordance with an aspect of the present disclosure.

FIG. 13E illustrates a flow chart for a method related to a 3D augmented reality model with locational awareness in accordance with an aspect of the present disclosure.

FIG. 13F illustrates a flow chart for a method related to a 3D augmented reality model with locational awareness in accordance with an aspect of the present disclosure.

FIG. 14 illustrates an example of a 3D augmented reality model showing mechanical and equipment information with locational awareness in accordance with an aspect of the present disclosure.

FIG. 15 illustrates an example of a 3D augmented reality model showing mechanical and equipment information with locational awareness in accordance with an aspect of the present disclosure.

FIG. 16 illustrates an example of a 3D augmented reality model showing mechanical and equipment information with locational awareness in accordance with an aspect of the present disclosure.

FIG. 17 illustrates an example of a 3D augmented reality model showing mechanical and equipment information with locational awareness in accordance with an aspect of the present disclosure.

FIG. 18 illustrates an example of a 3D augmented reality model showing mechanical and equipment information with locational awareness in accordance with an aspect of the present disclosure.

FIG. 19 illustrates an example of a 3D augmented reality model showing mechanical and equipment information with locational awareness in accordance with an aspect of the present disclosure.

FIG. 20 illustrates an example of a 3D augmented reality model showing mechanical and equipment information with locational awareness in accordance with an aspect of the present disclosure.

FIG. 21 illustrates an example of a 3D augmented reality model showing mechanical and equipment information with locational awareness in accordance with an aspect of the present disclosure.

FIG. 22 illustrates an example of a 3D augmented reality model showing mechanical and equipment information with locational awareness in accordance with an aspect of the present disclosure.

FIG. 23 illustrates an example of a 3D augmented reality model showing mechanical and equipment information with locational awareness in accordance with an aspect of the present disclosure.

FIG. 24 illustrates an example of a 3D augmented reality model showing mechanical and equipment information with locational awareness in accordance with an aspect of the present disclosure.

FIG. 25 illustrates an example of a 3D augmented reality model in accordance with an aspect of the present disclosure.

FIG. 26 illustrates an example of a 3D augmented reality model in accordance with an aspect of the present disclosure.

FIG. 27 illustrates an example of a 3D augmented reality model in accordance with an aspect of the present disclosure.

FIG. 28 illustrates a flow chart for a method related to a snagging application with locational awareness in connection with augmented reality functionality and in accordance with an aspect of the present disclosure.

FIG. 29 illustrates an example of a snagging application in accordance with an aspect of the present disclosure.

FIG. 30 illustrates an example of a snagging application in accordance with an aspect of the present disclosure.

FIG. 31A illustrates a flow chart for a method related to a health and safety hazard application with locational awareness in connection with augmented reality functionality and in accordance with an aspect of the present disclosure.

FIG. 31B illustrates a flow chart for a method related to a health and safety hazard application with locational awareness in connection with augmented reality functionality and in accordance with an aspect of the present disclosure.

FIG. 32 illustrates an example of a health and safety hazard application in accordance with an aspect of the present disclosure.

FIG. 33 illustrates an example of a system architecture in accordance with an aspect of the present disclosure.

FIG. 34 illustrates an example of a home-screen for a software application in accordance with an aspect of the present disclosure.

FIG. 35 illustrates an example of a marker for use with an augmented reality system in accordance with an aspect of the present disclosure.

FIG. 36 illustrates an example of a marker for use with an augmented reality system in accordance with an aspect of the present disclosure.

FIG. 37 illustrates an example of a marker for use with an augmented reality system in accordance with an aspect of the present disclosure.

FIG. 38 illustrates an example of usage of the augmented reality system in accordance with an aspect of the present disclosure.

FIG. 39 illustrates an example of the usage of the augmented reality system in accordance with an aspect of the present disclosure.

FIG. 40 illustrates an example of the usage of the augmented reality system in accordance with an aspect of the present disclosure.

FIG. 41 illustrates an example of the usage of the augmented reality system in accordance with an aspect of the present disclosure.

FIG. 42 illustrates an example of the usage of the augmented reality system in accordance with an aspect of the present disclosure.

### DETAILED DESCRIPTION

In facilities management and construction industries there is an information gap between the construction and occupation phases. For example, information regarding building equipment and installation that is critical in the construction phase may not be accurately conveyed to users in the occupation and facilities management phase. In one embodiment, a system built in accordance with the present disclosure may provide data management by extracting critical information for equipment, storing the appropriate information and providing the stored data based on proximity to the equipment, thus allowing the accurate conveyance of equipment information to users throughout the construction, occupation, and facilities management phases. In one embodiment the conveyance of equipment information may be done using augmented reality.

In construction and facilities management environments equipment is often located in visually obstructed areas. In one embodiment, a system built in accordance with the present disclosure provides a user with the ability to view the contents of a suspended ceiling or wall using augmented reality.

GPS or other location-based systems are not capable of accurately providing locational information within a building. In one embodiment, a two-dimensional (2D) floor map with locational awareness may be provided to a user using augmented reality.

Conventional construction and facilities management systems may create three-dimensional (3D) models of an environment that are expensive to produce and difficult to update. In one embodiment, a system built in accordance with the present disclosure may construct a three-dimensional representation of an environment using augmented reality that can be updated without having to reproduce a three-dimensional print thus providing an benefit over conventional systems.

Conventional digital operating and maintenance manuals may rely on the attachment of tracking tags such as quick response (QR) codes, barcodes, radio-frequency identification (RFID) tags, near-field communication (NFC) tags, Bluetooth® beacons and the like to identify specific equipment and retrieve digital operating and maintenance manuals for the specifically identified equipment. Accordingly, the conventional systems are both expensive and fault prone as this requires the maintenance of a large number of tracking tags that require battery changes and the replacement of faulty tracking tags. Furthermore, many tracking tags do not work in visually obstructed areas such as a suspended ceiling or wall. In one embodiment, a system built in accordance with the present disclosure may provide a solution to the problems created by the use of tracking tags by tracking objects (e.g., equipment) based on their locational information in the building and a user device's proximity to the defined locations corresponding to the objects. In this manner information may be displayed using augmented reality based on the positional information rather than tracking tags.

In one embodiment, a system built in accordance with the present disclosure may display information using augmented reality based on the positional information retrieved from the position information sensor. Information may include snags and hazards. In some embodiments, a snag may refer to a deviation from a building specification or minor fault. In contrast to conventional systems, where a user is typically prompted to enter the location of a snag or hazard, a system built in accordance with the present disclosure may allow a user to indicate a snag or a hazard by automatically detecting the location of a snag or hazard using the position information sensor.

In conventional environments a user may be inundated with a large amount of information related to equipment manuals that do not provide up-to-date information. Furthermore, an engineer or other personnel may not be able to access user manuals in proximity of the equipment. To address these problems, an embodiment of a system built in accordance with the present disclosure may provide a user with links to training media that dynamically changes based on a user device's proximity to equipment. Additionally, an embodiment of a system built in accordance with the present disclosure may provide a user with electronic operation and maintenance manuals when the user device is in proximity to equipment.

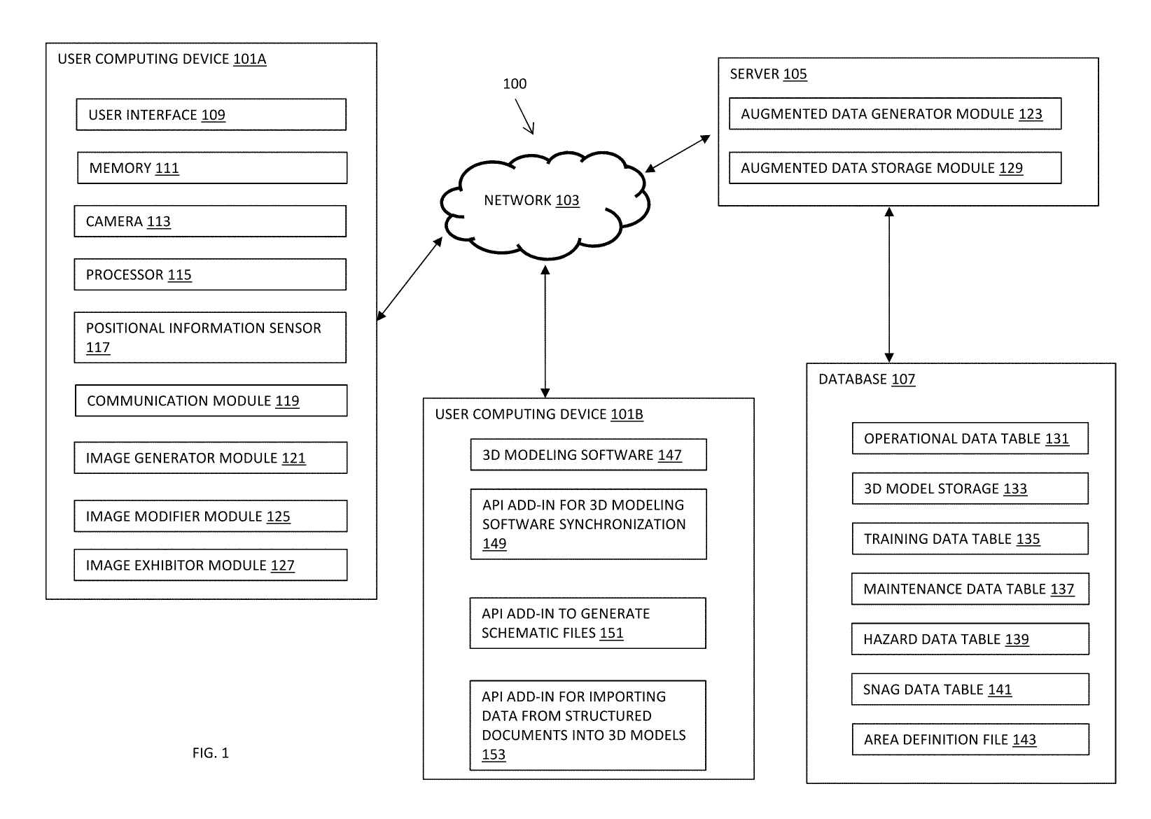

FIG. 1 illustrates a functional block diagram for an improved augmented reality system 100 for use in connection with construction and facilities management environments. As illustrated in FIG. 1, the system 100 may include one or more user computing devices 101A, 101B (collectively, 101) communicatively coupled to a network 103 to at least one server 105. In the illustrated embodiment, two separate user computing devices 101A and 101B are depicted. In one embodiment, the user computing device 101A may be portable, and the other user computing device 101B may be a desktop, or other stationary device. The server may also be communicatively coupled to a database 107. Although one computing device may be shown and/or described, multiple computing devices may be used. Conversely, where multiple computing devices are shown and/or described, a single computing device may be used.

Example user computing devices 101 may include, but is not limited to, a mobile phone, desktop computer, laptop, portable digital assistants (PDAs), smart phones, tablets, ultra books, net-books, laptops, multi-processor systems, microprocessor-based or programmable consumer electronics, game consoles, set-top boxes, or any other communication device that a user may use to access the network 103.

In one embodiment, the user computing device 101A may include (without limitation) a user interface 109, memory 111, camera 113, processor 115, positional information sensor 117, communication module 119, image generator module 121, image modifier module 125, and image exhibitor module 127.

In one embodiment, the user interface 109 may be configured to have a display and a user input/output components. Example displays may include a plasma display panel (PDP), a light emitting diode (LED) display, a liquid crystal display (LCD), a projector, or a cathode ray tube (CRT) and the like. Example output components may include acoustic components (e.g., speakers), haptic components (e.g., a vibratory motor, resistance mechanisms), other signal generators, and so forth. Example input components may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like. The input components may also include one or more image-capturing devices, such as a digital camera 113 for generating digital images and/or video.

In one embodiment, the memory 111 may be transitory or non-transitory computer-readable memory and/or media. Memory 111 may include one or more of read-only memory (ROM), a random access memory (RAM), a flash memory, a dynamic RAM (DRAM) and a static RAM (SRAM), storing computer-readable instructions that are executable by processor 115.

In one embodiment, the camera 113 may be an image capturing device capable of generating digital images and/or video. Although a single camera 113 is depicted, the user computing device may include multiple cameras 113.

In one embodiment, the processor 115 carries out the instructions of one or more computer programs stored in the non-transitory computer-readable memory 111 and/or media by performing arithmetical, logical, and input/output operations to accomplish in whole or in part one or more steps of any method described herein.

In one embodiment, the positional information sensor 117 may be configured to define a location of the user computing device 101 in relation to a representation of the operating environment the user is within. The representation of the operating environment may be stored in the memory 111 of the user computing device 101 and/or the database 107 (in which case it is provided to the positional information sensor 117 by way of the communication module 119, the network 103, and the augmented data storage module 129 of the server 105). The representation of the operating environment may be referred to as an area definition file 143.

In one embodiment, the communication module 119 may be configured to transmit and receive information from the at least one server 105 via the network 103.

In one embodiment, the server 105 and the user computing device 101 may include one or more modules. Modules may include specially configured hardware and/or software components. In general, the word module, as used herein, may refer to logic embodied in hardware or firmware or to a collection of software instructions. Generally, the modules described herein refer to logical modules that may be combined with other modules or divided into sub-modules despite their physical organization or storage.

The image generator module 121 may be configured to engage one or more cameras 113 located on the user computing device 101 to generate an image. The image generator module 121 may also be configured to receive a generated image from the camera 113 by way of the communication module 119.

The image modifier module 125 may be configured to retrieve an image generated by the camera 113, retrieve augmented data from the database 107 via the augmented data storage module 129 based on positional information generated from the positional information sensor, and modify the retrieved image to represent the augmented data within the image. Modifying the retrieved image may include overlaying or integrating at least a portion of the augmented data onto or into the retrieved image. For example, schematic vent flow diagrams may be overlayed upon an image of ceiling tiles. In another example, a hazard sign may be overlayed upon an image of a pipe. Various examples are discussed further below. The image modifier module 125 may modify the image at the server 105 or on the user computing device 101.

The image exhibitor module 127 may be configured to receive a modified image from the communication module 119 and cause the system to present one or more of the generated image and the modified image using the display on the user interface 109.

In one embodiment, a second computing device 101B may include 3D modeling software 147, an application interface add-in for 3D modeling software synchronization 149, an application interface for generating and uploading schematic diagrams 151, and an application interface for importing data from structured documents into 3D models 153.

In one embodiment, the 3D modeling software 147 may include a 3D model along with operating and maintenance data, risk assessments and method statements, training data (i.e., links to training videos), snagging information and other structured data that may be embedded in the individual 3D objects of the 3D model.

In one embodiment, the application interface add-in for 3D modeling software synchronization 149 may be configured to synchronize changes between the 3D model and textual data on a building information management software application (e.g., Revit®) and the user computing devices 101 that display augmented reality. Example application interface add-ins may include an add-in to import data from structured technical submittal documents into specific 3D objects in the model, an add-in to import data from structured Risk Assessment and Method Statement documents into specific 3D objects in the model, and an add-in to import data from structured links to training videos into specific 3D objects in the model.

In one embodiment, an application interface for generating and uploading schematic diagrams 151 may be configured to save a 3D model and upload the saved file into a 3D model storage in the cloud. For example, the application interface for generating and uploading schematic diagrams 151 may be configured to save and upload geometry definition files, including but not limited to, for example, Object (OBJ) or JavaScript® Object Notation (JSON) files.

In one embodiment, an application interface for importing data from structured documents into 3D models 153 may be configured to copy the individual structured fields in a structured technical submittal document and import those fields into the selected 3D object in the model.

In one embodiment, the network 103 may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks.

The server 105 may include an augmented data generator module 123, and an augmented data storage module 129.

The augmented data generator module 123 may be configured to provide a software application on a display of the user interface 109. In one embodiment, the software application may be configured to provide a template to a user to receive information regarding an object (e.g., device, equipment) within an environment. A user may then use the user interface 109 to enter information regarding the object. Information may include operational information, schematic information, training information, maintenance information, hazard information, snagging information and the like. The augmented data generator module 123 may be further configured to receive positional information for an object from the positional information sensor. The augmented data generator module 123 may be further configured to combine the user entered information regarding the object and the positional information from the positional information sensor that corresponds with the object to generate augmented data. The augmented data generator module 123 may then provide the generated augmented data to the augmented data storage module 129 for storage on database 107.

The augmented data storage module 129 may be configured to store, update, and retrieve augmented data from the database 107.

The image generator module 121, the augmented data generator module 123, the image modifier module 125, the image exhibitor module 127, and the augmented data storage module 129 may form the back end of one or more applications that are downloaded and used on the user computing device 101.

In one embodiment, the database 107 may include various data structures such as data tables, object-oriented databases and the like. Data structures in the database 107 may include an operational data table 131, a 3D model storage 133, a training data table 135, a maintenance data table 137, a hazard data table 139, a snag data table 141, and an area definition file 143. The data structures discussed herein may be combined or separated.

In one embodiment, the operational data table 131 may store data and information related to the operation of equipment. Data may be stored in a non-proprietary data format for the publication of a subset of building information models (BIM) focused on delivery asset data as distinct from geometric information such as Construction Operations Building Information Exchange (COBie) and the like. Alternatively, the operational data table 131 may be stored in a building data sharing platform such as a Flux® data table and the like. In one embodiment, operational data may be combined with maintenance data and stored in text based database fields including hyperlinks stored as text and literature provided by manufacturers stored in any suitable format such as PDF format.

In one embodiment, the 3D model storage 133 may store data and information related to mechanical and electrical equipment including (but not limited to) schematic diagrams. In one embodiment, schematic data may include 3D models in JSON or OBJ format(s) and the like. In one embodiment, the 3D model storage 133 may include a 3D representation of the environment. In one embodiment, the 3D model storage 133 may be structured as a database table with 3D model files uploaded in database records. In one embodiment, the 3D model storage 133 may be stored as a collection of sequentially named 3D model files saved in the cloud. In one embodiment, the 3D model storage 133 may include 3D models related to maintenance and equipment services only. In one embodiment, the 3D model storage 133 may include architectural, and structural information and the like. In one embodiment, the 3D model storage 133 may include maintenance, equipment, architectural, and structural information. In one embodiment, the various models may be stored in one or more sub-data structures.

In one embodiment, the training data table 135 may store data and information related to training video locations, training manuals, audio and video clips, multimedia and the like. In one embodiment, the training data may be stored as text based fields and hyperlinks.

In one embodiment, the maintenance data table 137 may store data and information related to the maintenance requests and processes of equipment. Data may be stored in Construction Operations Building Information Exchange (COBie) format or the like. In one embodiment, maintenance data table 137 may be combined with operational data table 131 and stored in text based database fields including hyperlinks stored as text and literature provided by manufacturers stored in any suitable format such as PDF format.

In one embodiment, the hazard data table 139 may store data and information related to hazard markers and notes related to safety and health hazards. The hazard data table 139 may also include the position the hazard markers and related information should be displayed in relation to the corresponding area definition file. The hazard data table 139 may include text based and numeric fields that indicate the location coordinates of the hazards along with descriptions of hazards, risk assessments and method statements.

In one embodiment, the snag data table 141 may store data and information related to markers and notes as well as the position the markers and notes should be displayed in relation to the corresponding area definition file. The snag data table 141 may include text based and numeric fields that indicate the location coordinates of the snags (or faults) along with descriptions of snags, including the identification of equipment being snagged and the contractor responsible for rectifying the snag or fault.

In one embodiment, the area definition file 143 may store data and information related to one or more area definition files generated in accordance with the systems and methods described below. In one embodiment, the area definition file 143 may be generated by loading an existing area learning file, conducting a re-localization that establishes the location of the device, and then expanding the learned area by walking through the additional areas from the user computing device's re-localized location as a starting point. Using this process a new area definition file may be created that contains the previously learned area along with additional areas that are combined into the same area definition file. Alternatively, in some embodiments, the area definition file 143 may store area information obtained by interactions between the user computer device 101 and fixed anchor targets in an environment.

In one embodiment, the operational data table 131, the 3D model storage 133, training data table 135, maintenance data table 137, hazard data table 139, area definition file 143, and snag data table 141 may form one or more tables within a SQL database. Each field of the various tables may be named in accordance with Construction Operations Building Information Exchange (e.g., BS1192-4 COBie) parameter naming standards.

In one embodiment the data stored in database 107 may be linked between the various illustrated data structures. For example, in one embodiment, each 3D object may have a globally unique identifier (GUID) that is replicated in each data table entry that is relevant to the 3D object. For example, snags, manual information, training information, hazards and other information relevant to a specific 3D object may reside in multiple data tables but be linked to the same 3D object via the GUID.

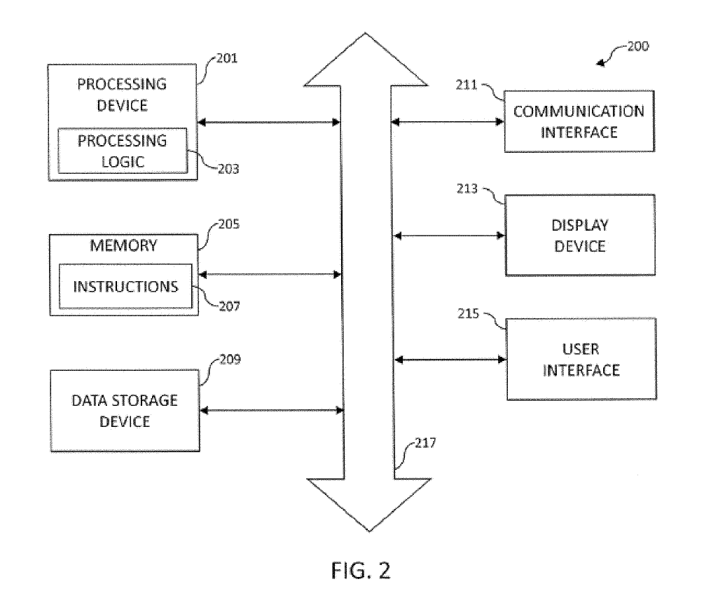

FIG. 2 illustrates a functional block diagram of a machine in the example form of computer system 200, within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, each of the user computing device 101 and the server 105 may be implemented by the example machine shown in FIG. 2 (or a combination of two or more of such machines).

Example computer system 200 may include processing device 201, memory 205, data storage device 209 and communication interface 211, which may communicate with each other via data and control bus 217. In some examples, computer system 200 may also include display device 213 and/or user interface 215.

Processing device 201 may include, without being limited to, a microprocessor, a central processing unit, an application specific integrated circuit (ASIC), a field programmable gate array (FPGA), a digital signal processor (DSP) and/or a network processor. Processing device 201 may be configured to execute processing logic 203 for performing the operations described herein. In general, processing device 201 may include any suitable special-purpose processing device specially programmed with processing logic 203 to perform the operations described herein.

Memory 205 may include, for example, without being limited to, at least one of a read-only memory (ROM), a random access memory (RAM), a flash memory, a dynamic RAM (DRAM) and a static RAM (SRAM), storing computer-readable instructions 207 executable by processing device 201. In general, memory 205 may include any suitable non-transitory computer readable storage medium storing computer-readable instructions 207 executable by processing device 201 for performing the operations described herein. Although one memory device 205 is illustrated in FIG. 2, in some examples, computer system 200 may include two or more memory devices (e.g., dynamic memory and static memory).

Computer system 200 may include communication interface device 211, for direct communication with other computers (including wired and/or wireless communication), and/or for communication with network 103 (see FIG. 1). In some examples, computer system 200 may include display device 213 (e.g., a liquid crystal display (LCD), a touch sensitive display, etc.). In some examples, computer system 200 may include user interface 215 (e.g., an alphanumeric input device, a cursor control device, etc.).

In some examples, computer system 200 may include data storage device 209 storing instructions (e.g., software) for performing any one or more of the functions described herein. Data storage device 249 may include any suitable non-transitory computer-readable storage medium, including, without being limited to, solid-state memories, optical media and magnetic media.

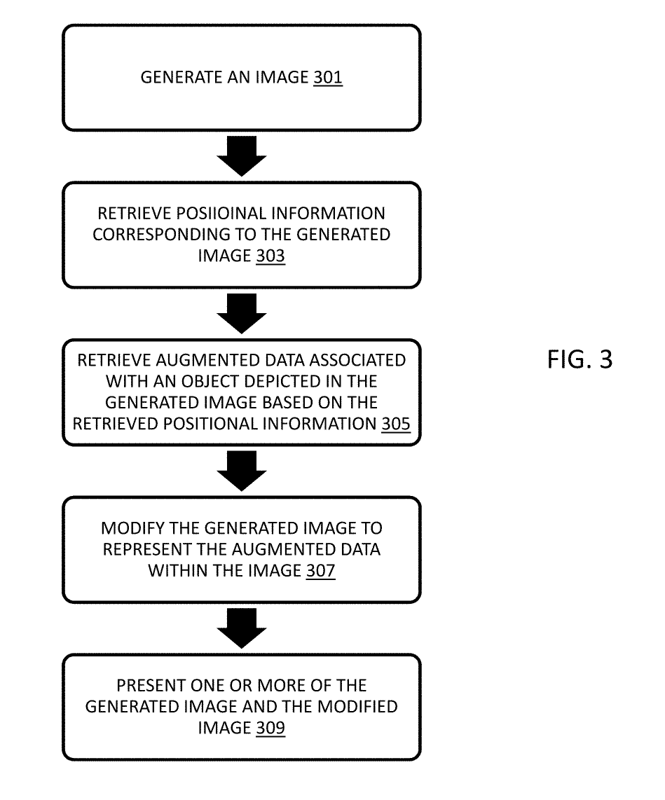

FIG. 3 illustrates a flowchart for a method in accordance with the present disclosure. At step 301, the method generates an image. Step 301 may be facilitated by the camera 113 of the user computing device 101 and/or the image generator module 121 illustrated in FIG. 1. At step 303, the method retrieves positional information corresponding to the generated image. Step 303 may be facilitated by the positional information sensor 117 illustrated in FIG. 1. At step 305, the method retrieves augmented data associated with an object depicted in the generated image based on the retrieved positional information. Step 305 may be facilitated by the augmented data storage module 129 illustrated in FIG. 1. At step 307 the method may modify the generated image to represent the augmented data within the image. Step 307 may be facilitated by the image modifier module 125. At step 309 the method may present one or more of the generated image and the modified image. Step 309 may be facilitated by the image exhibitor module 127, the communication module 119, and a display of the user interface 109.

The modules may be used in connection with the components of the user computing device (both illustrated in FIG. 1) to produce one or more software applications available to the user computing device that are specially configured to provide a user with augmented reality functionalities. Example software applications may include a software application for providing augmented data such as floor plan information responsive to a user device position, a software application for providing operation and maintenance manuals responsive to a user device position, a software application for providing training data responsive to a user device position, a software application for overlaying 3D mechanical and electrical information on a user device image responsive to a user device position, a software application for displaying snags responsive to a user device position and a software application for displaying safety hazards responsive to a user device position. Although separate software applications are stated, it is envisioned that one or more of the functionalities described above may be combined or separated into any number of software applications.

The systems and methods described herein provide an improved augmented reality system that has applications in the construction and facilities management industries. The improved augmented reality system includes a user interface device having locational awareness by way of a positional information sensor. Using the positional information sensor, the user interface device may create a representation of the user's environment. Augmented data can be displayed within an image of the user's environment based on the location of the user device and previously stored augmented data that is cued to positional information.

In one embodiment, locational awareness provided by the positional information sensor may be integrated with a two-dimensional representation of a user's environment. For example, a two-dimensional floor plan may be overlayed with a graphical indicator (e.g., red dot, arrow) indicating the real-time position of a user device based on positional information retrieved from the positional information sensor on the user device. Alternatively, portions of a two-dimensional floor plan augmented with manufacturing and equipment information may be displayed in accordance with positional information retrieved from the positional information sensor on the user device.

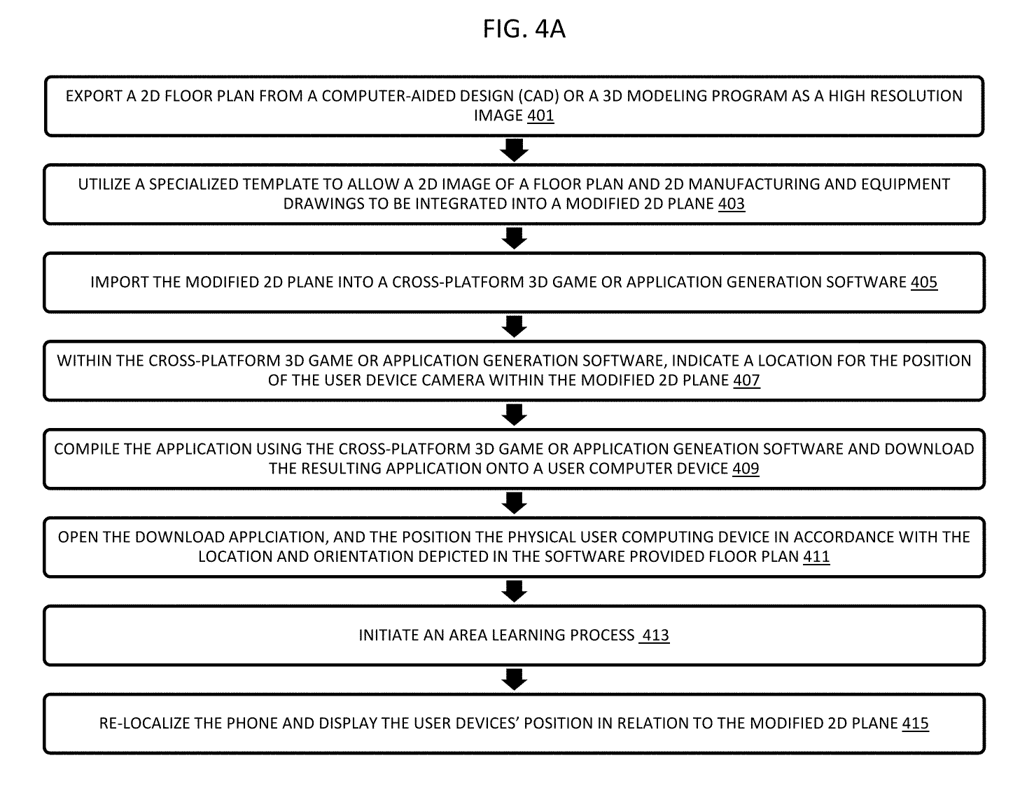

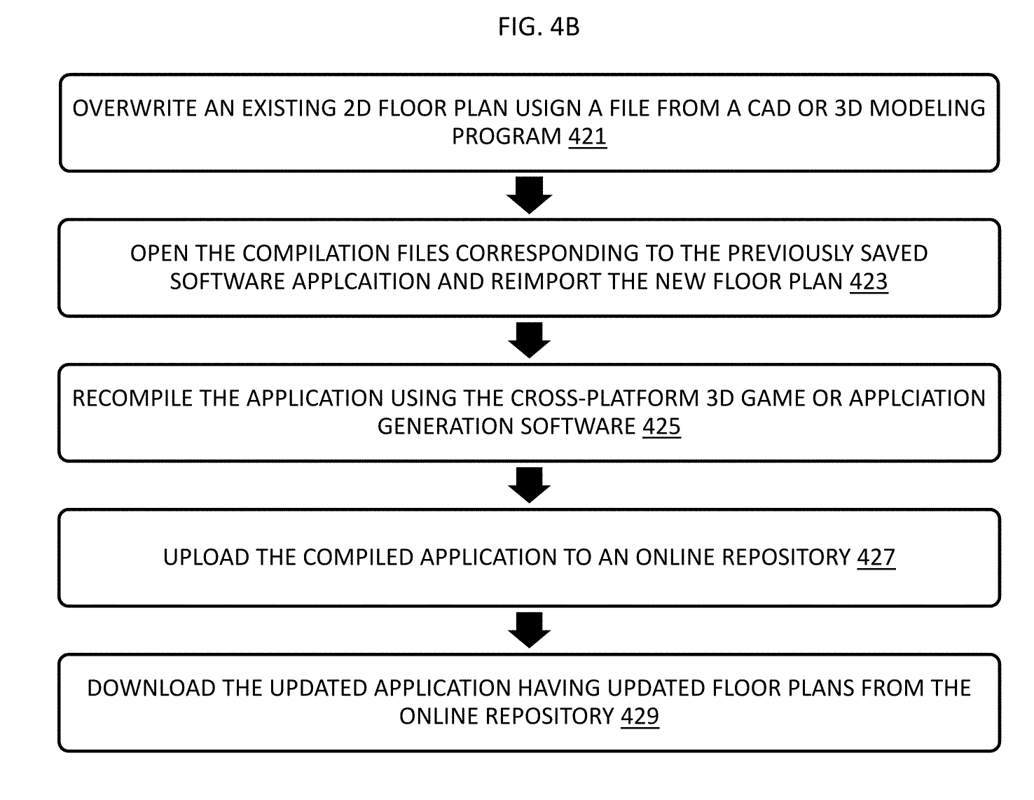

In one embodiment, locational awareness using the positional information sensor may be pre-calibrated using area learning. A method related to pre-calibrating the locational awareness and generating a two-dimensional floor plan overlayed with a graphical indicator of a user device's real-time position is illustrated in FIG. 4A. In a first step 401, a user may export a 2D floor plan from a computer-aided design (CAD) or a 3D modeling program as a high resolution image, in a second step 403, a specialized template may be used to allow a 2D image of a floor plan and 2D manufacturing and equipment drawings to be integrated into a modified 2D plane in a 3D environment. In other words, the modified 2D plane may include the floor plan as well as manufacturing and equipment drawings. In a third step 405, the modified 2D plane may then be imported into a cross-platform 3D game or application generation software. Example cross-platform 3D game or application generation software includes Unity® software by Unity Technologies, Inc., Blender® by Blender Foundation, Unreal Engine® by Epic Games, GameMaker: Studio® by YoYo Games, Construct 3® by Scirra Ltd., Godot licensed by MIT, Kivy licensed by MIT and the like. In a fourth step 407, the user may indicate a location for the position of the user device camera within the modified 2D plane. Using the cross-platform 3D game or application generation software, in a fifth step 409, the user may compile the application and download the resulting application onto a user computing device. In a sixth step 411, after opening the application, the user may position in the physical user computing device in accordance with the location and orientation depicted in the software provided floor plan. In one embodiment, the location and orientation depicted in the software may indicate a clearly identifiable part of the floorplan and corresponding building such as a corner of a wall. In a seventh step 413, the user may initiate an area learning process. In an eighth step 415, once the user computing device has learned the area, the phone re-localizes and displays the user devices' position in relation to the modified 2D plane.

The area learning process of step 413 may utilize the positional information sensor 117 illustrated in FIG. 1. The positional information sensor 117 may include one or more of inertial motion sensors, a fish eye camera, one or more front cameras, and infrared depth perception sensors. The area learning process of step 413 may include a user device starting from a known location and orientation (see step 411) and traversing the external environment. The area learning process may be configured to record all identifiable geometric shapes identified by the positional information sensor 117 and determine the relative location of all the identifiable geometric shapes to the starting location. In this manner, the area learning process of step 413 may construct a map of the environment. The resulting map may then be compared and reconciled with the floorplan. The area learning process of step 413 may generate an area definition file that includes an internal map of recognizable shapes within an environment along with a coordinate representation of all of the recognizable shapes.

The re-localization process of step 415 may include the user initiating an application on the user device and the user/user device subsequently being prompted to traverse the surrounding environment. While traversing the environment, the camera of the user device may be configured to face forwards until the user device is able to recognize an object via the camera that corresponds to an object in the area definition file. Once a recognizable object is found a portion of the display on the user device may provide an indication to the user of a location and orientation where the user device should be placed. A second portion of the display on the user device may provide an image feed from the camera of the user device. As a user navigates the user device into the indicated location and orientation, the 2D or 3D content may be overlayed on the live image feed from the camera of the user device.

In one embodiment, the re-localization process in step 415 may include the user initializing an application and being prompted to point the camera at a two-dimensional unique marker image permanently fixed at a location with known and recorded coordinates. In some embodiments, the recorded coordinates may be stored in database such as database 107. In such an embodiment, using the camera, the user computing device 101 may recognize the marker image and align its starting position relative to the detected image. Multiple unique marker images can be placed throughout the site, each with their specific coordinates. This process can be repeated with another nearby marker image if the relative motion tracking drifts out of alignment. In other words, the re-localization process may be aided by the identification of one or more markers (having known positions) in the environment being scanned (i.e., learned).

A method for modifying an existing 2D floor plan is illustrated in FIG. 4B. In a first step 421, a user may overwrite an existing 2D floor plan using a file from a CAD or 3D modeling program. In a second step 423, a user may open the compilation files corresponding to the previously saved software application and reimport the new floor plan. In a third step 425, the user may recompile the application (using the cross-platform 3D game or application generation software). In a fourth step 427, the user may upload the compiled application to an online repository (e.g., iTunes® store, Android® app store). In a fifth step 429, a user may download the updated application (and corresponding updated floor plans) from the online repository.

In one embodiment, when an updated floor plan is downloaded from the online repository, the user device may undergo a modified area learning process. The modified area learning process may include the user device walking the portion of the area corresponding to the modified area, recording all identifiable geometric shapes identified by the positional information sensor 117 within the modified area, and determining the relative location of all the identifiable geometric shapes in the modified area to the starting location. The modified area learning process may be substantially similar to the process described in connection with step 411 of FIG. 4A. The modified area learning process may produce area definition data that is then appended to an existing area definition file. Subsequently, the user device may undergo a re-localization process in step 413 for the new portion of the area definition file.

In one embodiment, an application may check the cloud repository for updates to the graphics, data and area definition file. A download may commence whenever an update is found.

In one embodiment, the specialized template referred to in step 403 may be configured to allow a 2D image of floor plans and 2D maintenance and equipment drawings to be loaded onto a 2D plane. The 2D plane in the 3D environment may be overlayed on the floorplan in augmented reality.

In one embodiment, the user computing device may be a device capable of running an augmented reality platform such as the Tango® platform developed by Google®, the ARCore® also developed by Google® and the ARKit developed by Apple®. Example devices may include the Lenovo Phab®, the Zenfone® AR, Google® Pixel®, and the like. In some embodiments, the disclosed systems may utilize a cross-platform 3D game or application generation software such as Unity® software, and the like.

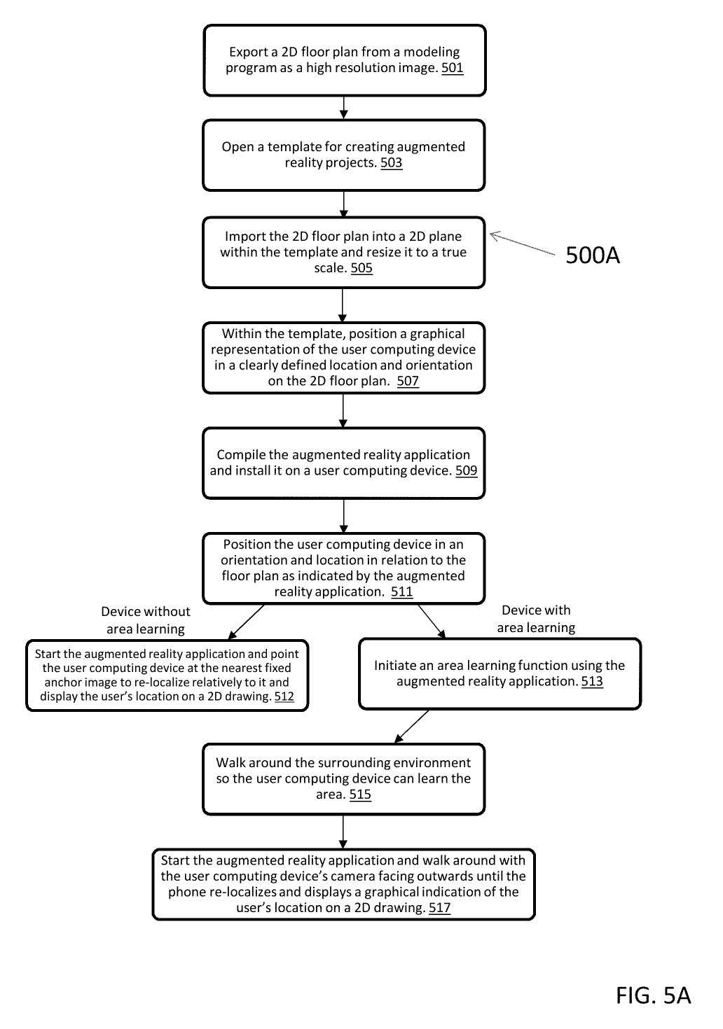

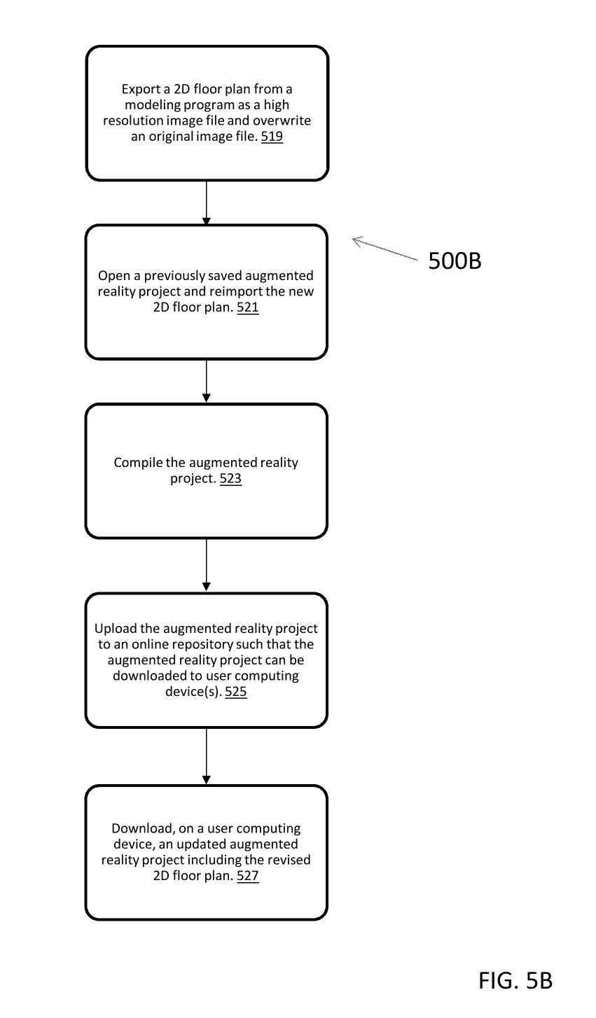

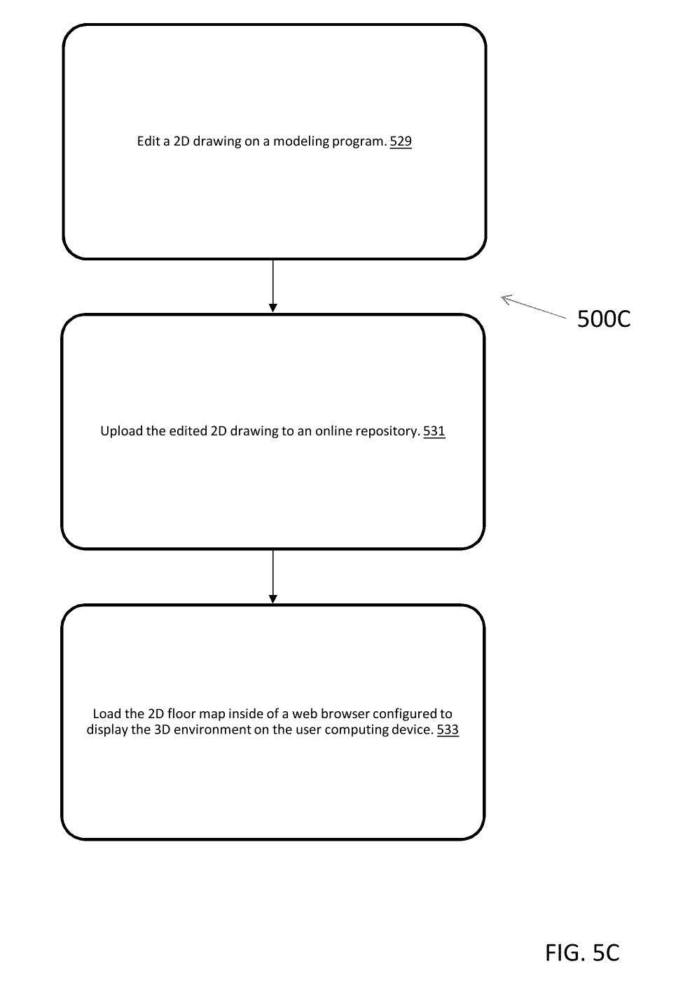

FIG. 5A illustrates the initial setup of a 2D floor plan with locational awareness for a user device. As illustrated in step 501, first a 2D floor plan is exported from a CAD or 3D modeling program as a high resolution image. At step 503, a specialized template may be opened. In one such embodiment, the specialized template may be developed and programmed on a cross-platform 3D game or application generation software with a software development kit configured for an augmented reality platform. At step 505, the floor plan exported in step 501 may be imported into the template, or a software asset bundle. As discussed above, the custom template may allow a 2D image of a floor plan and a 2D maintenance and equipment drawing to be loaded onto a 2D plane in a 3D environment. When importing the modified 2D floor plan in step 505, the modified 2D floor plan may be resized to a true scale. At step 507, a graphical image corresponding to the user computing device may be positioned within the software application in a clearly defined location and orientation on the 2D floor plan. At step 509, the augmented reality application may be compiled and then installed on the user computing device. In a non-limiting example, a cross-platform 3D game or application generation software asset bundle may be compiled and installed on a device running the augmented reality platform. Once the application is opened, at step 511, the physical user computing device may be positioned in the same location and orientation that is indicated graphically in the augmented reality software application. At step 513, if the user device includes area learning functionality it may then undergo an area learning process. The area learning process may involve walking around the entire floor, covering all the rooms, walkable spaces, and corridors in multiple directions in the environment, in step 515. Once the area learning process is completed, in step 517 the software application may be started, and the user may be prompted to walk around with the user device cameras facing forwards until the phone re-localizes and displays the user's location superimposed on a 2D floor plan containing equipment and manufacturer information. Alternatively, at step 512, if the user device does not include area learning functionality, the augmented reality application may be started and the user computing device may be pointed at the nearest fixed anchor image to re-localize the user computing device with respect to the fixed anchor image and display the user's location on a 2D floor plan.

FIG. 5B illustrates how the 2D floor plan containing equipment and manufacturer information may be updated. In a first step 519, the user may export a new 2D floor plan from a computer-aided design (CAD) or 3D modeling program as an image file that then overwrites an existing image file. In a second step 521, the user may open the previously saved project in a gaming engine or augmented reality software creation platform and reimport the new image file. In a third step 523, the user may recompile the files associated with the gaming engine or augmented reality software creation platform. In a fourth step 525, the files associated with the gaming engine or augmented reality software creation platform may be uploaded to the online repository so that it is accessible for download by other user devices. In a fifth step 527, a user may download the updated application and the revised asset bundles containing the new 2D floor plan.

In one embodiment, files associated with the gaming engine or augmented reality software may be downloaded and launched at runtime. In this manner, modifications, revisions, or updates to the floor plan (such as those illustrated in FIGS. 4B and 5B) can be performed without requiring an application on the user device to be recompiled or reinstalled. The files associated with the gaming engine or augmented reality software may allow content and geometry information to be separated from other aspects of the software application.

In an alternative embodiment, a data sharing platform such as Flux® or ARCore® by Google® may be used in place of a cross-platform 3D game or application generation software such as Unity® software. In an alternative to using a specialized template, the image update process to the end user may be simplified by downloading a graphical file from a data sharing platform and regenerating graphical elements. In a non-limiting example, a JavaScript® Object Notation (JSON) file from a synchronized data sharing account may be downloaded and graphics may be regenerated programmatically by interpreting the description of the items in the JSON file. For example, 3D geometry information may be extracted from a JSON file. Data sharing platforms may be used to synchronize the 3D model, building information modeling (BIM) data, and cloud data, to generate a JSON file that contains structured information that can be used to reproduce an 2D floor plan with equipment and manufacturer data in another software program. The BIM data may be in any suitable format such as (but not limited to) Revit® data format. The reproduction process may involve generating polylines, surfaces, faces, and basic 3D components to recreate an approximation of the BIM data. In one embodiment, the reproduction may be done in real-time.

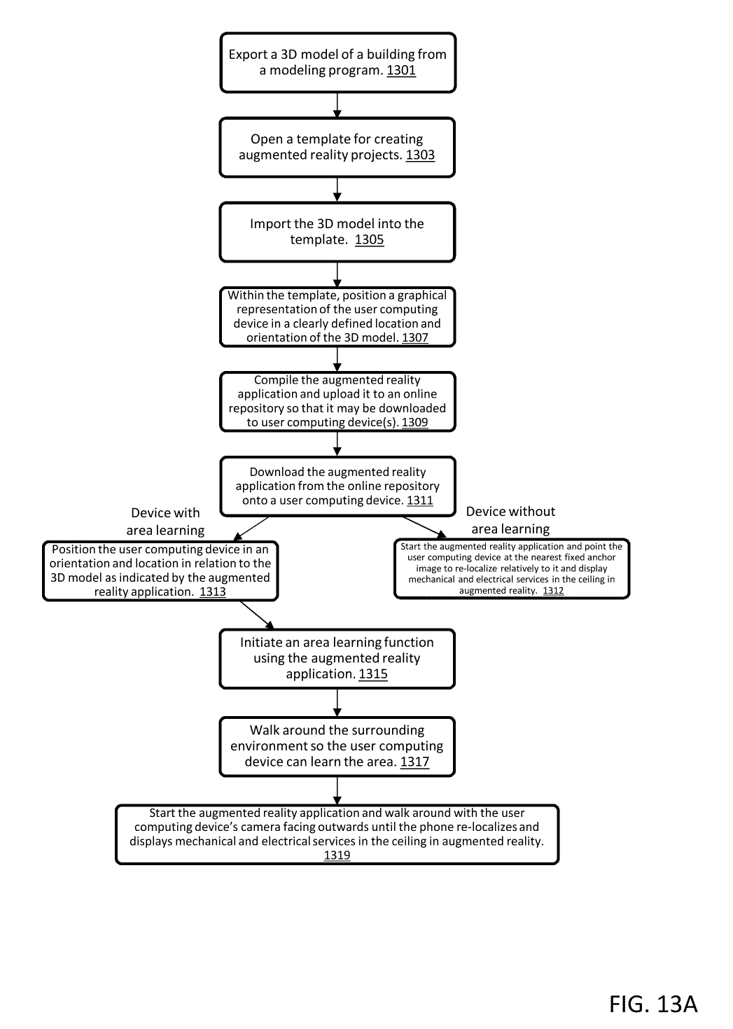

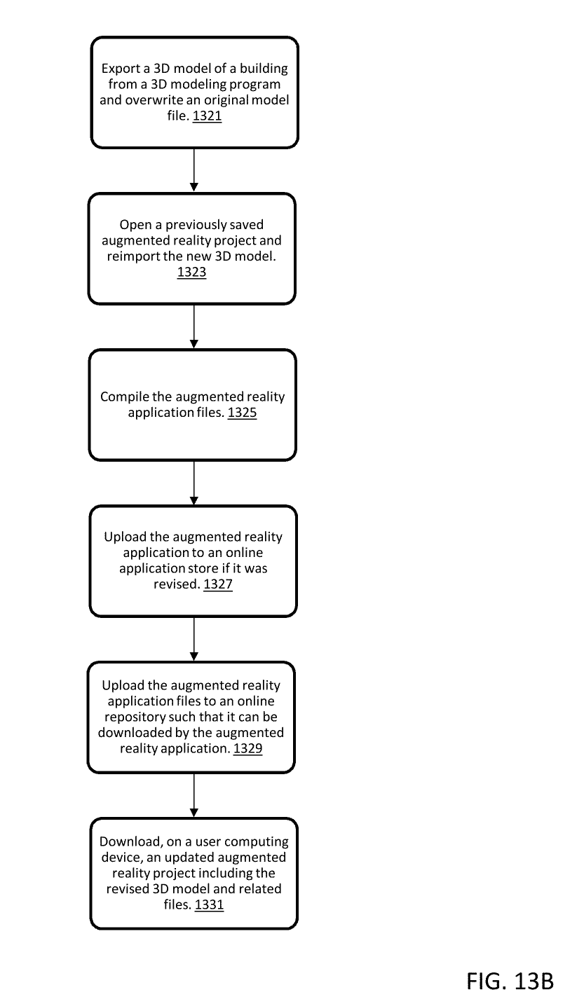

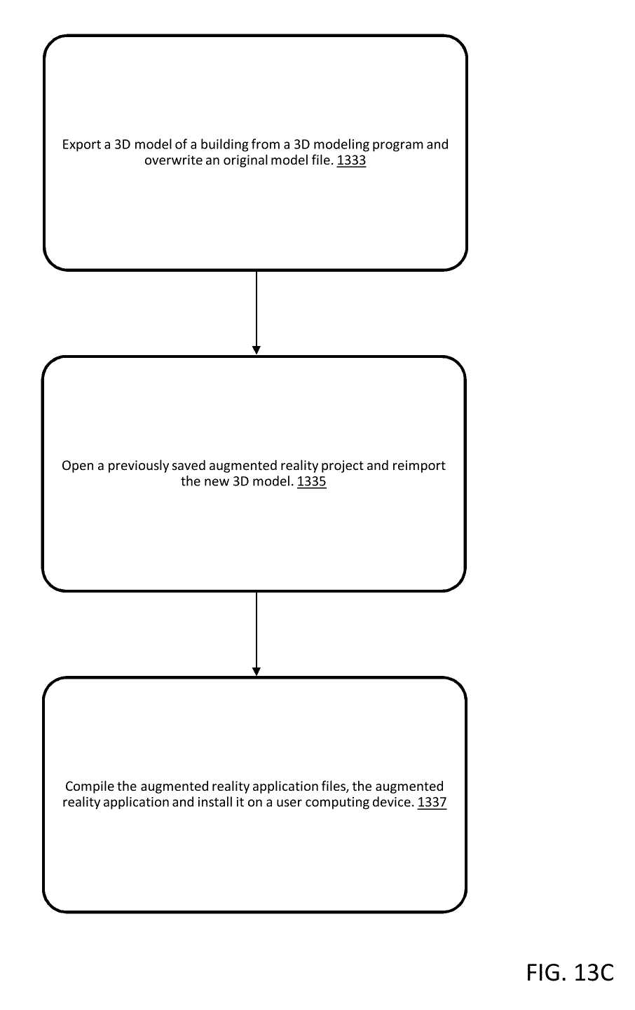

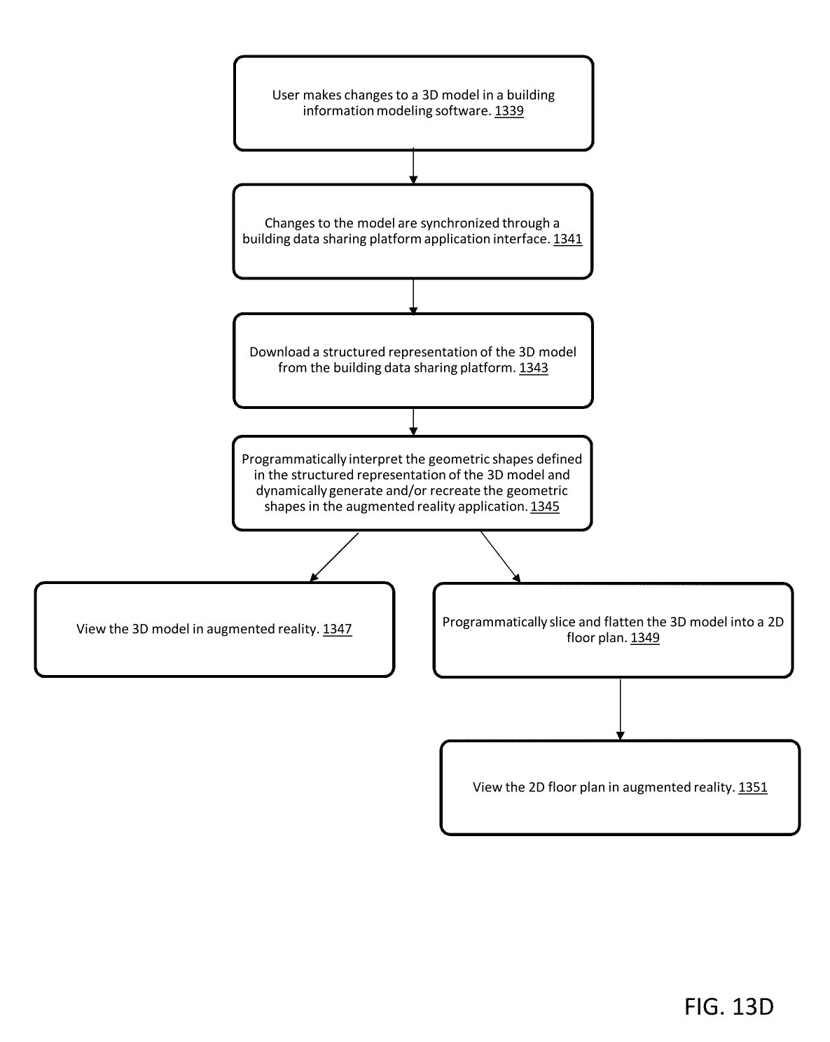

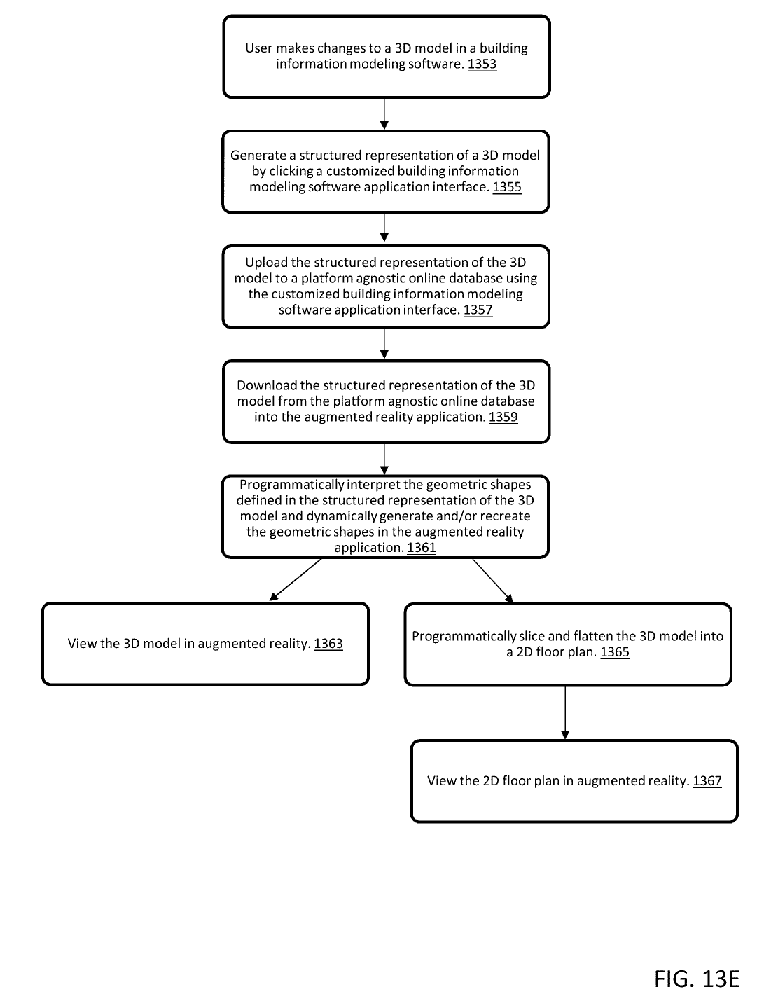

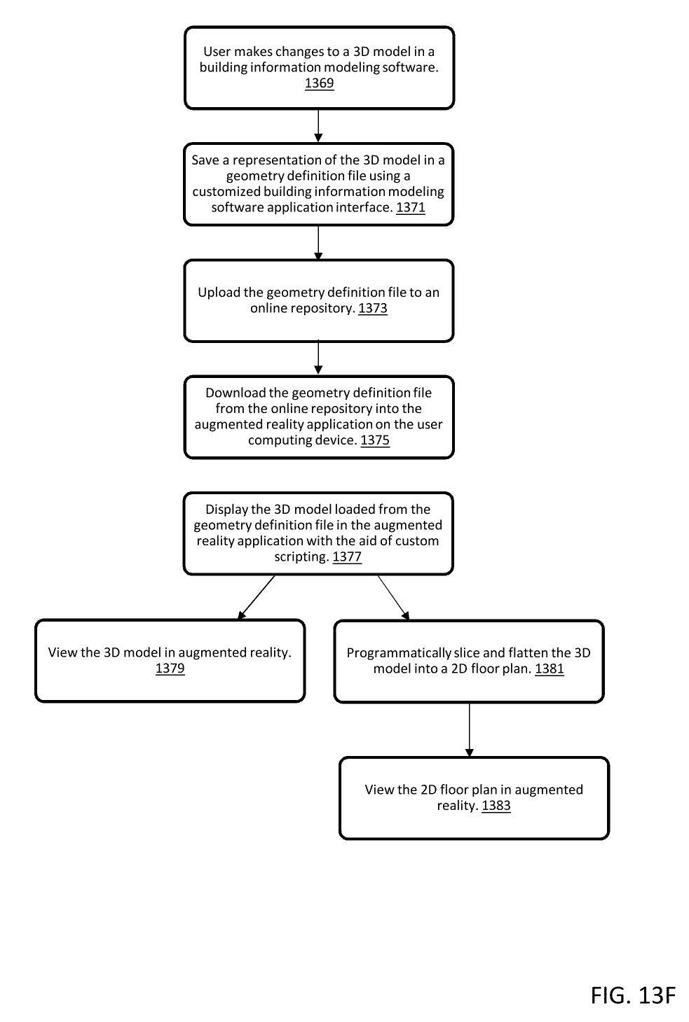

In contrast to the processes illustrated in FIGS. 4 and 5, an alternative embodiment using a data sharing platform such as Flux® or Autodesk® Forge, may involve the steps of synchronization with Flux® or Autodesk® Forge, generation of a JSON representation of the 3D model with the aid of a Flux® or Autodesk® Forge plugin for Revit®, downloading the JSON file using a phone application and programmatically generating the geometric shapes described in the Flux® or Autodesk® Forge JSON file. Example embodiments that utilize a data sharing platform such as Flux® or Autodesk® Forge are described in connection with FIGS. 13D to 13F.

In an alternative embodiment, as illustrated in FIG. 5C, the 2D floor plan may be displayed in augmented reality with the aid of an embedded web browser window overlaid as a flat plane on the floor in augmented reality. This process may utilize the web publication features of Google® Flux® and Autodesk® Forge, which facilitate the display of CAD and BIM graphics on the web browser. In this embodiment, the computing device may load the latest 2D floor plan by refreshing the webpage containing the 2D floor plan published by the CAD program to a specified URL. As illustrated in FIG. 5C in step 529 a user may edit a 2D drawing using a CAD program or a 3D model using a 3D modeling program. At step 531 the edited 2D or 3D model may be uploaded to an online repository with 3D modelling application plugin such as Google® Flux® plugin, Autodesk® Forge or the equivalent. At step 533 a user may load the 2D floor plan application within a web browser placed within the 3D environment to see an augmented image.

As discussed in relation to FIGS. 4B and 5B, an area definition file that defines the environment the user computing device is operating in may be downloaded from an online repository. In one embodiment, the area definition files may be stored in an area definition file 143 of the database 107 and may be accessed via the augmented data storage module 129 and the network 103 by the user computing device 101. In this manner, one user computing device 101 may perform the processor and memory intensive area learning processes and allow other user computing devices 101 to utilize the same area definition files.

In an alternative to the embodiments illustrated in FIGS. 4B and 5B where the application is compiled and uploaded to a cloud server and subsequently downloaded and installed on a user device, in one embodiment, an application may be loaded onto an external memory device (e.g., USB drive) and directly loaded onto a user device.

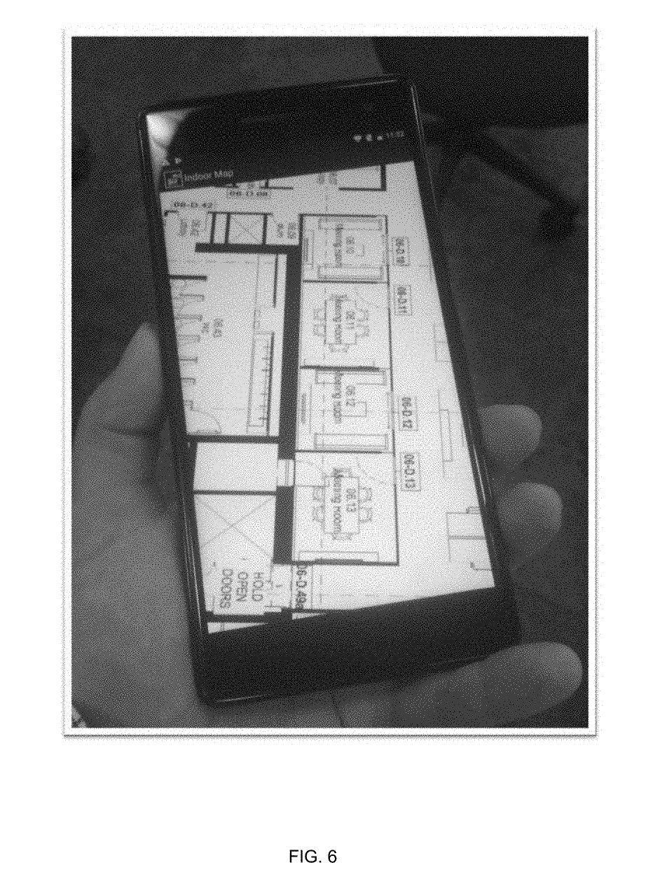

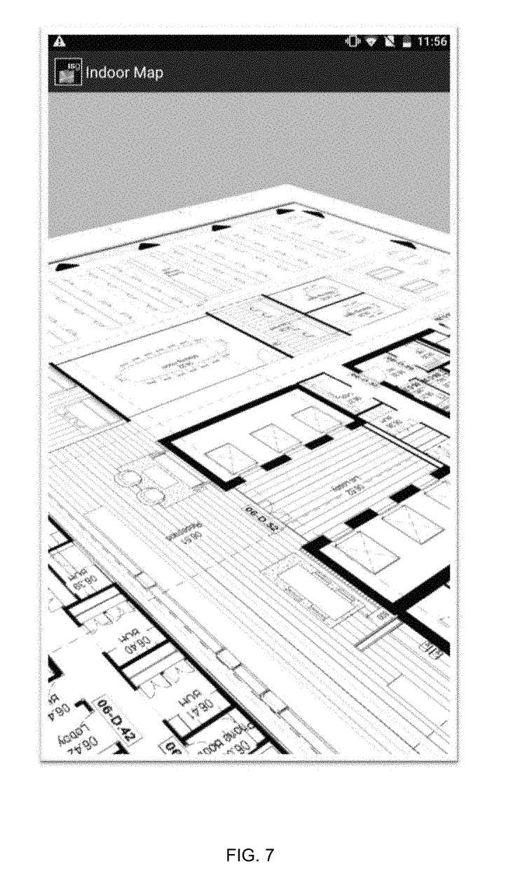

FIGS. 6 and 7 illustrate examples of the 2D floor map. As illustrated, the portion of the 2D floor map containing both floor plan information and maintenance and equipment information is based on the location of the user computing device within the 2D floor map. In other words, the displayed augmented information is responsive to the positional information provided by the user computing device. In one embodiment, the 2D floor maps illustrated in FIGS. 6 and 7 may results from the processes illustrated and discussed in connection with FIGS. 4 and 5.

It is envisioned that in one embodiment, multiple user computing devices may work in conjunction to continuously re-learn an area in the event that there are changes to the environment (e.g., furniture is moved). Each of the user computing devices may upload the amended area definition file to the area definition file 143 so that it is accessible by the remaining user computing devices. The remaining user computing devices may then navigate through the updated environment after undergoing the re-localization process only.

As discussed above, using positional information from a positional information sensor, a user computing device may create a representation of the user's environment on which augmented data may be presented. The improved system may display the augmented data based on locational awareness provided by the positional information sensor. In one embodiment, the systems and methods described herein may be integrated into an application capable of being displayed on the user computing device that provides augmented data in the form of operation and maintenance manuals for equipment located within an environment. For example, if a user device is within a boiler room, operation and maintenance manuals for all equipment in the ceiling, walls, floor, and the interior of the boiler room, may be provided to a user by overlaying the augmented data (i.e., operation and maintenance manuals) on an image generated by the camera of the user device.

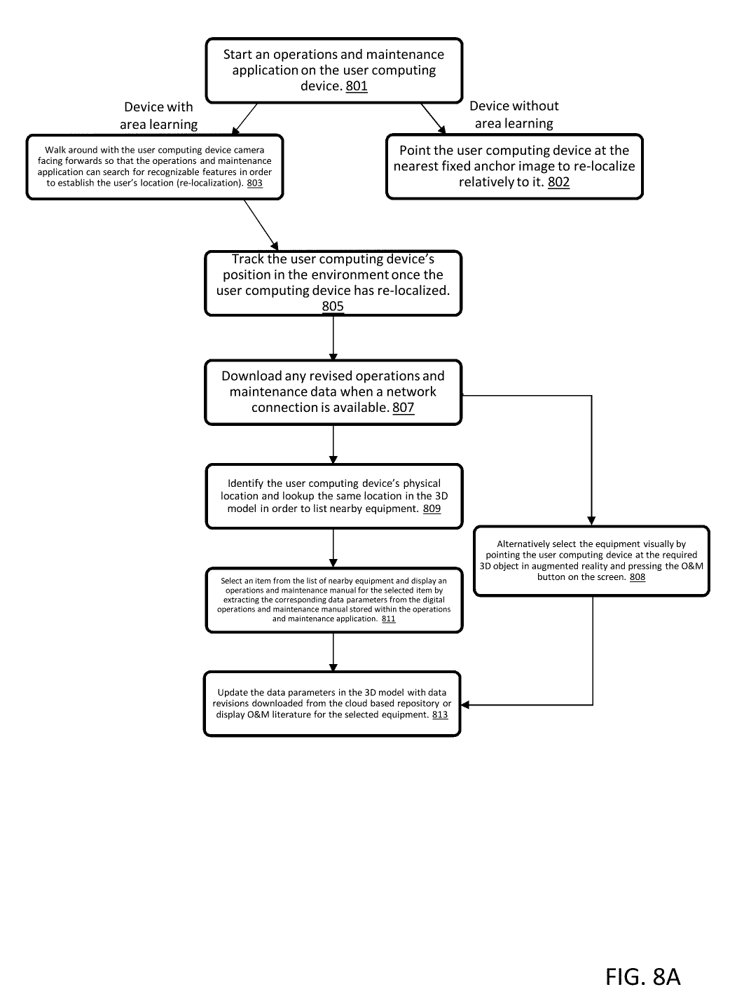

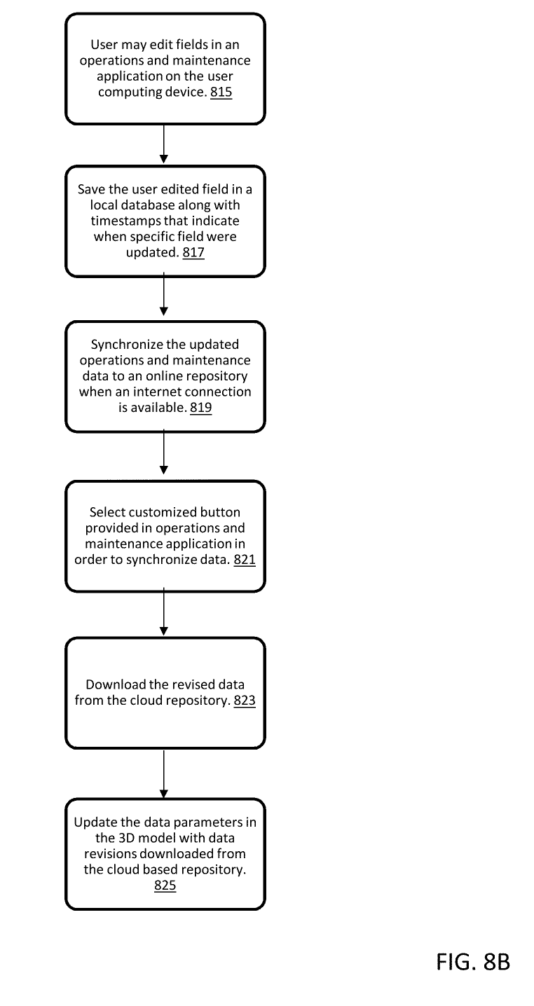

FIG. 8A illustrates the process by which a user may access location-based operation and maintenance manual information. At step 801 the user may access an augmented reality based operations and maintenance application on the user computing device 101 that is configured to provide location-based operation and maintenance manual information. At step 803, if the user is utilizing a user computing device 101 capable of area learning, the user may traverse the environment with the camera 113 positioned outward so that the application can search for recognizable features from the obtained image and establish the user's location in a process similar to re-localization (described above). Recognizable features may include (but are not limited to) room configurations, corridor shapes, furniture, doors, windows, support columns. As discussed above, the re-localization process may utilize infrared depth perception and stereoscopic vision information by way of the positional information sensor 115. In an alternative to step 803, if the user computing device is not capable of area learning, at step 802, the user computing device may be pointed to a fixed anchor image in order to re-localize the user computing device 101 with respect to the fixed anchor image. At step 805 once the re-localization process is completed, the application may be able to determine the user device's position using the position information sensor. In one embodiment the position information may be presented in coordinate form relative to the area definition file for the environment. At step 807, the operation and maintenance data may be retrieved from the operational data table 131 and the maintenance data table 137 by the augmented data storage module 129 and then transmitted via the network 103 to the user computing device 101, where it is locally stored in memory 111. In one embodiment, the operational and maintenance data may be stored in a database such as a SQLite database and the like on the user computing device 101. The operational and maintenance data may include locational tag for each piece of equipment. For example, x-y-z coordinates relative to the origin of the corresponding area definition file may be stored alongside the operation and maintenance data for the piece of equipment located at that x-y-z coordinate. Operational and maintenance data stored in the SQLite database may replicate or follow the same COBie parameter naming convention used in the database 107 for consistency. In one embodiment all parameters may have consistent and unique names across all applications and storage repositories. The revised operations and maintenance data may be downloaded when a network connection is available.

At step 809, the positional information sensor 117 may be used to determine the physical position of the user computing device 101 within the environment. In one embodiment the determined position may be in coordinate format (e.g., x-y-z coordinates relative to the point of origin in the corresponding area definition file). The determined position may be used to look up the location within the 3D model of the learned area to list nearby equipment within the 3D model. The list of nearby equipment may be exhibited on a display of the user interface 109. In one embodiment, the list of nearby equipment may be sorted and displayed in accordance to the equipment's proximity to the user device's location. In another embodiment, the list of nearby equipment may be sorted and displayed in accordance to the equipment's uniclass categories. A user may then select an item from the list of nearby equipment such that operation and maintenance data for the selected item is exhibited in the display of the user interface 109 by extracting the corresponding data parameters from the operation and maintenance data that is locally stored in the memory 111. In particular, the extraction process may include looking up the selected item in the local SQLite database and using data stored related to the selected item to populate a scrollable operation and maintenance form with structured data that is extracted from the SQLite database. At step 811 a user may select an item from the list of nearby equipment and display an operations and maintenance manual for the selected item by extracting the corresponding data parameters from the digital operations and maintenance manual stored within the operations and maintenance augmented reality application.

In an alternative embodiment, in place of steps 809 and 811, in step 808, the user may select the equipment visually by pointing the user computing device 101 at the required 3D object in augmented reality and pressing a corresponding button that is linked to operations and maintenance.

At step 813, data parameters in the 3D model may be updated with data revisions that were previously downloaded from the cloud based repository (see step 807). Alternatively, or additionally, at step 811, the user may display operations and maintenance literature of the selected equipment.

In one embodiment the equipment in augmented reality may be selected visually by pointing the device at the specified object until the name and ID number of the device is shown on the screen.

This is achieved by using the raycasting feature in a game engine, which continuously fires a virtual beam in the forward direction from the center of the forward camera and reports which objects the beam collides with. As all 3D objects in the model have names and ID numbers, these numbers can be referenced to the corresponding O&M literature, issue reporting details, training videos and any other information relevant to the selected equipment.

Upon the required equipment is selected, the user may click on the relevant button (O&M, Snagging, Training Video etc.) to view or input the relevant information.

In one embodiment steps 809, 811, and 813 of the process illustrated in FIG. 8A may be carried out locally on the user computing device 101 without connection to the internet or network 103. The ability to provide operation and maintenance data without an internet connection may be favorable in environments where internet connection is unavailable such as a plant room or basement.

Alternatively, in an environment having internet or network connections, a synchronized local storage database (such as the SQLite database described in relation to step 807) may not be necessary. In such an embodiment, operation and maintenance data may be downloaded in real-time from the database 107 by way of the network 103.

Operation and maintenance data may include manufacturer contact details, supplier contact details, subcontractor contact details, equipment model number, equipment type, specification reference, specification compliance/deviation confirmation, package code, cost code, uniclass product classification code, uniclass system classification code, system abbreviation, equipment description, warranty details, sustainability data (e.g., Building Research Establishment Environmental Assessment Method (BREEAM), Leadership in Energy and Environmental Design (LEED), etc.), planned preventive maintenance instructions, commissioning data, unique equipment reference, risk assessment, method statement, maintenance logs, and the like.

We turn now to FIG. 8B which illustrates a method for receiving updates to operation and maintenance data from the user computing device 101. In one embodiment, the system 100 may exhibit on the display of the user interface 109 of the user computing device 101 an operations and maintenance application that is configured to receive object information and positional information for an object (e.g., piece of equipment). The system 100 may be further configured to generate augmented data associated with the object in accordance with the received object information and received positional information by way of the augmented data generator module 123. Furthermore, the system 100 may be configured to store the augmented data on a database 107 communicatively coupled to the at least one server 105 by way of the augmented data storage module 129.

FIG. 8B illustrates a processes corresponding the components illustrated in FIG. 1. In particular at step 815 a user may edit one or more fields of an operations and maintenance application configured for updating operation and maintenance manual data that is displayed in the display of the user interface 109. The edits and/or field may correspond to object information. The object information may be combined with positional information retrieved from the positional information sensor 117. The combined information may be used to populate a database structure such as a local SQLite database, a Google® Flux® table, and the like. At step 817 the edited fields may be stored in the local database along with timestamps that indicate when specific fields were updated. At step 819 the updated operation and maintenance data may be synchronized with the online repository (or database 107) when a network 103 connection is available. During the synchronization process, if multiple data entries (received from one or more user computing devices) correspond to a single piece of equipment, the data entry having the latest timestamp for a particular piece of equipment may be stored in the online repository. At step 821 the user may elect to synchronize data (as in perform step 819). In one embodiment, a custom button may be provided within the software application that the user may select in order to synchronize the data. In step 823 the user computing device 101 may download revised data from the cloud repository (or database 107). In step 825 the user computing device may update the locally stored data parameters based on the revised data downloaded from the cloud repository at step 823.

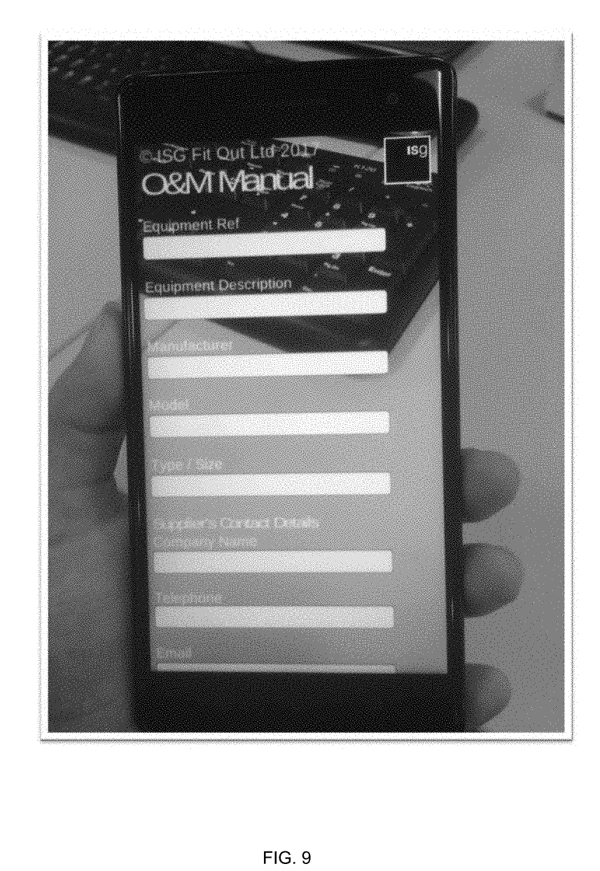

FIG. 9 illustrates an example of an application configured to update operation and maintenance manual data that is displayed in the display of the user interface 109 in accordance with the process discussed in relation to FIG. 8B. As illustrated, operation and maintenance data may include one or more fields including (without limitation): equipment reference, equipment description, manufacturer, model, type/size, supplier contact details including company name, telephone and email.

In one embodiment, the systems and methods described herein may be integrated into an application capable of being displayed on the user computing device that provides augmented data in the form of training media for equipment located within an environment. For example, if a user device is located in a kitchen the application may display training media (e.g., instructions, audio prompts, videos) related to a microwave located within the kitchen overlayed on an image generated by the camera of the user device.

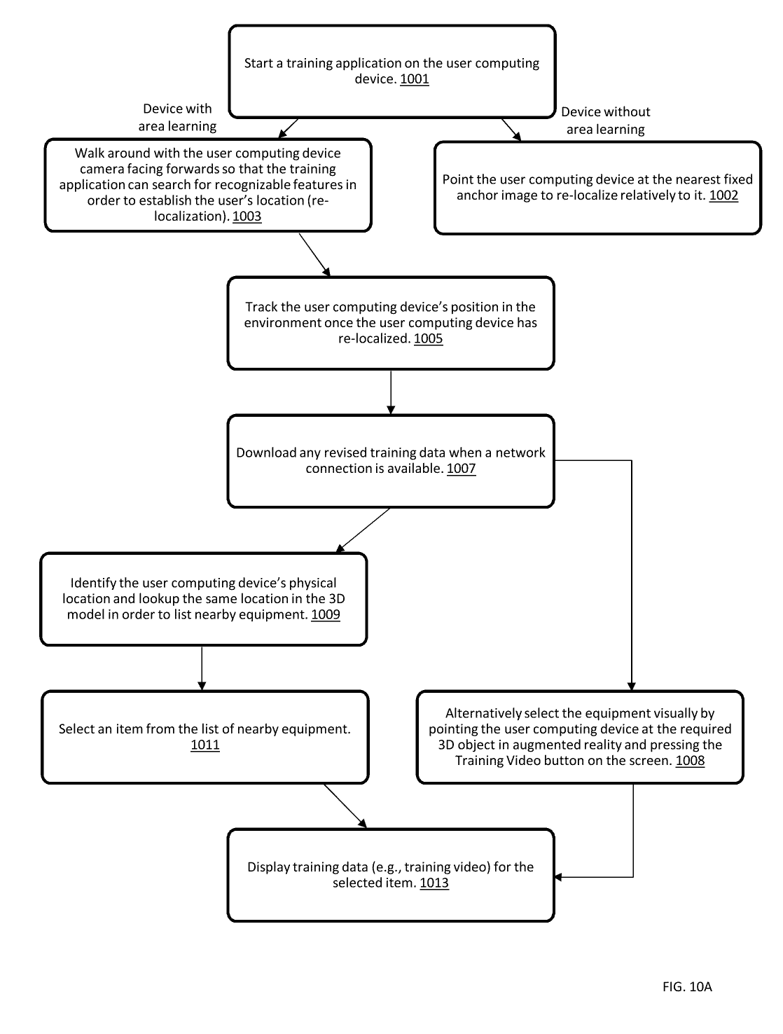

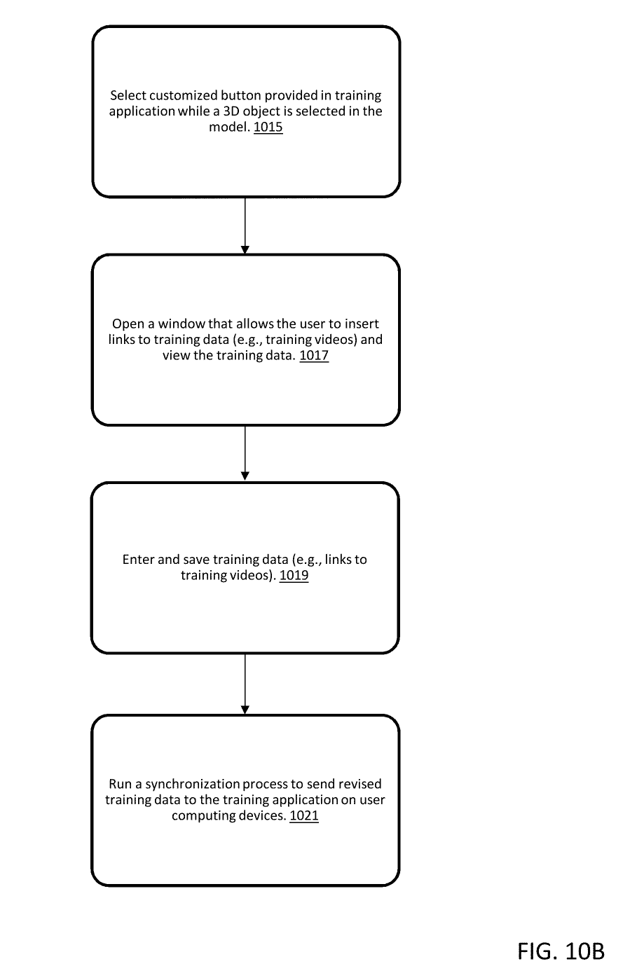

FIG. 10A illustrates the process by which a user may access location-based training information. At step 1001 the user may access a training application on the user computing device 101 that is configured to provide location-based training information. If the user computing device includes area learning components, at step 1003 the user may traverse the environment with the camera 113 positioned outward so that the training application can search for recognizable features from the obtained image and establish the user's location in a process similar to re-localization (described above). Recognizable features may include (but are not limited to) room configurations, corridor shapes, furniture, doors, windows, support columns. As discussed above, the re-localization process may utilize infrared depth perception and stereoscopic vision information by way of the positional information sensor 115. Alternatively, if the user computing device does not include area learning components, at step 1002 the user computing device may be pointed at the nearest fixed anchor image in order to re-localize the device relative to the anchor image. At step 1005 once the re-localization process is completed, the training application may be able to determine the user device's position using the position information sensor 115. In one embodiment the position information may be presented in coordinate form relative to the area definition file 143 for the environment. At step 1007, training data may be downloaded when a network connection is available. Training data may be retrieved from the training data table 135 by the augmented data storage module 129 and then transmitted via the network 103 to the user computing device 101. In one embodiment the training data may include one or more hyperlinks to streamed online videos. In another embodiment the training data may include textual or audio information. The training data may include a locational tag for each piece of equipment as discussed above.

At step 1009, the positional information sensor 117 may be used to determine the position of the user computing device 101 within the environment. In one embodiment the determined position may be in coordinate format (e.g., x-y-z coordinates relative to the point of origin in the corresponding area definition file). The determined position may be used to look up the location within the 3D model of the learned area to list nearby equipment within the 3D model. The list of nearby equipment may be exhibited on a display of the user interface 109. In one embodiment, the list of nearby equipment may be sorted and displayed in accordance to the equipment's proximity to the user device's location. In another embodiment, the list of nearby equipment may be sorted and displayed in accordance to the equipment's uniclass categories.

At step 1011 a user may select an item from the list of nearby equipment.

In an alternative to steps 1009 and 1011, at step 1012, the user may visually select the equipment by pointing the user computing device at the required 3D object in augmented reality and pressing a corresponding button (e.g., Training Video) on the screen of the user computing device.

The corresponding training data may be presented to the user in step 1013. For example, if the training data includes hyperlinks to a website or an online database providing a training video, at step 1013 the application may open a web browser that is configured to be shown on the display of the user interface 109. The training video may then be played within the web browser. Example websites or online databases include a YouTube® channel and the like. Alternatively, if the training data is textual information, the textual information may be displayed in the display of the user interface 109. If the training data includes audio information, the audio information may be played through a speaker of the user computing device 101.

We turn now to FIG. 10B which illustrates processes enabled by an application that is configured to update training data. In step 1015 the user may elect to update training data while an object within the 3D representation of the environment is selected. In one embodiment the user may make this election by selecting a displayed icon. In step 1017 the application may provide the user with a window that allows the user to input training data (e.g., links to training videos). The window may also be configured to allow the user to view the training data. At step 1019 the user may save their entered training data. At step 1021 the user may run a synchronization process to transmit the entered training data to an online repository, and store the training data in the training data table 135, such that the entered training data is available to users of other user computing devices 101.

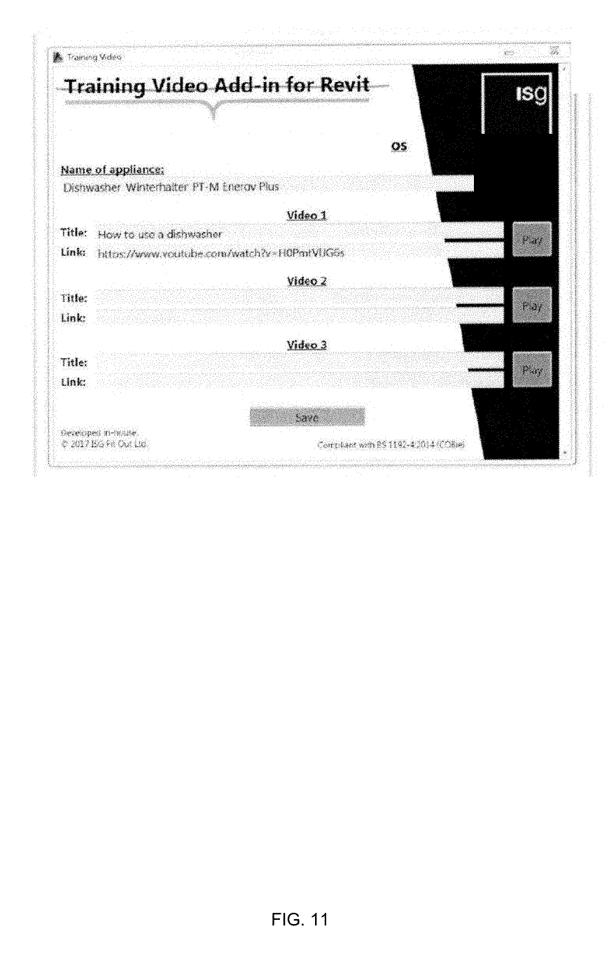

FIG. 11 illustrates an example of the application that may be provided to the user with a window that allows the user to input training data. In the depicted embodiment, the user may provide training data including links to training videos located online and a brief description of the training video.

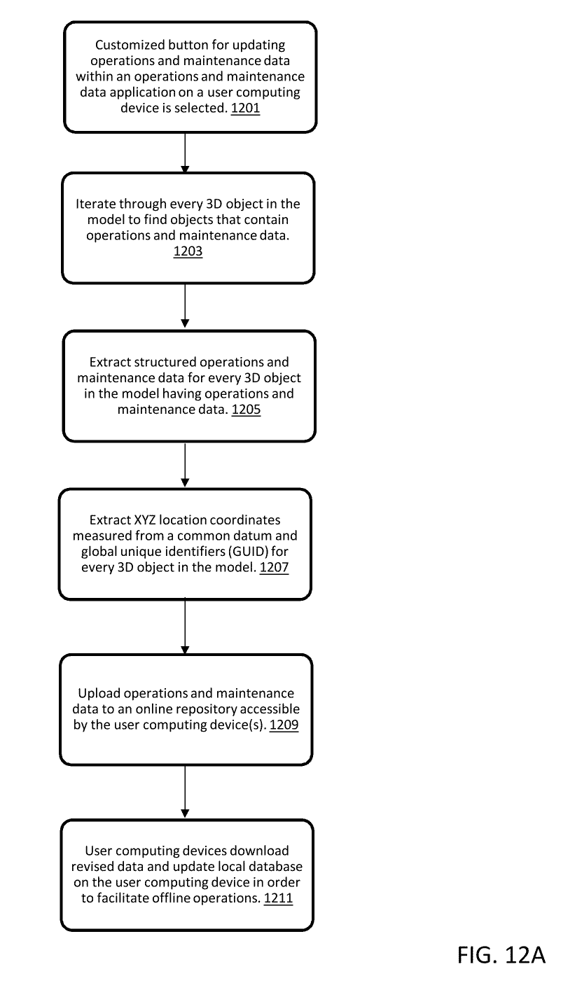

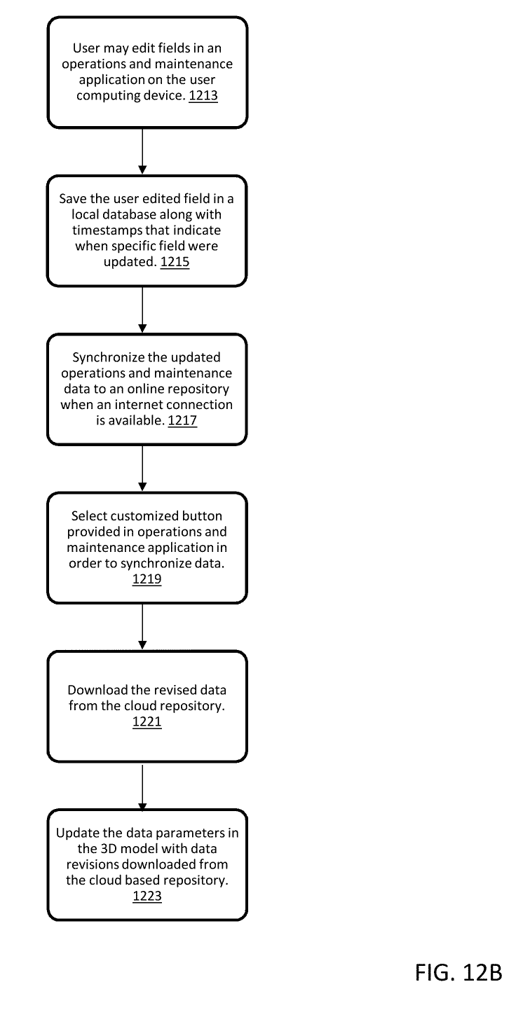

We turn now to FIGS. 12A and 12B, which correspond to processes for synchronizing operation and maintenance data in the building information management (BIM) file (e.g., Revit® data) used for the 2D floor map (see step 403 of FIG. 4) based on updates to an online repository (such as database 107) for operation and maintenance data.

FIG. 12A illustrates a process for sending operation and maintenance data updates to a user computing device 101. At step 1201 a user selects the relevant application. At step 1203 the application iterates through every 3D object in the building information management file (or 3D floorplan map) to find objects that contain operation and maintenance data. At step 1205 structured operation and maintenance data is extracted for each object. Structured operation and maintenance data may include manufacturer contact details, equipment information such as models, serial numbers, size, and the like, warranty information, planned preventative maintenance instructions, sustainability information, commissioning information and the like. At step 1207 location information may be extracted for each object. Location information may include x-y-z coordinates measured form a common datum, global unique identifiers (GUIDs) and the like. Each object in the 3D floorplan map may have uniquely defined x-y-z coordinates and GUIDs. The x-y-z coordinates and GUID information may provide the ability to search for equipment by location or proximity to a specific location (such as a location provided by the positional information sensor 117). The extracted data may be generated as a spreadsheet, data table and the like. At step 1209, the data may be uploaded to an online repository accessible by one or more of the software applications described herein such as database 107 illustrated in FIG. 1. At step 1211 the revised data may be downloaded and used to update local databases on user computing devices.

FIG. 12B illustrates how a building information management file (e.g., Revit® data) used for the 2D floor map may be updated based on data received from user computing devices 101. At step 1213 a user may edit one or more fields presented in an operations and maintenance application on a display of a user interface 109. At step 1215 the edited field may be saved in a local database along with timestamps indicative of when specific fields were updated. At step 1217 the updated data saved on the local database may be synchronized with an online repository (e.g., database 107) when a network connection is available. At step 1219, the user may elect to synchronize their user computing device 101 with the cloud repository. At step 1221, the user may download the revised data from the cloud repository onto their respective user computing device 101. At step 1223 the data parameters in the building information management file (e.g., Revit® data) may be updated with data revisions downloaded from the cloud based data repository.

In one embodiment, the spatial and locational awareness of the user computing device 101 discussed in connection with the systems and methods described above, may be used to provide an overlay of mechanical and electrical components on a 3D representation of an environment. For example, vents, ducts, and other components may be shown when a user computing device 101 is pointed towards a ceiling.

FIG. 13A illustrates a process that provides an initial setup for 3D augmented reality with locational awareness for a user computing device 101. The process illustrated in FIG. 13A may be analogous to the process illustrated in FIG. 5A. At step 1301 a 3D model of a building from a 3D modeling program may be exported into a 3D game engine or software application development software. For example, the 3D model may be in the Filmbox® format or the like. At step 1303 a specialized template may be opened. At step 1305, the 3D model exported in step 1301 may be imported into the template (e.g., Unity® software asset bundle). The custom template may allow a 3D model and mechanical and equipment drawings to be combined in a 3D environment. In one embodiment the mechanical and equipment drawings may be from the 3D model storage 133. At step 1307, a graphical image corresponding to the user computing device may be positioned within the software application (Unity® software) in a clearly defined location and orientation in the 3D model. At step 1309, the files corresponding to the augmented reality application may be compiled and uploaded to an online repository (such as database 107). At step 1311, the augmented reality application may be compiled and uploaded to an online application store (e.g., Android® app store) and installed into user computing devices from the online application store.

Once the application is opened, in a user computing device capable of area learning, at step 1313, the physical user computing device may be positioned in the same location and orientation that is indicated graphically in the software application. At step 1315, the user device may then undergo an area learning process. The area learning process may involve walking around the entire floor, covering all the rooms, walkable spaces, and corridors in multiple directions in the environment, at step 1317. Once the area learning process is completed, in step 1319 the software application may be started, and the user may be prompted to walk around with the user device cameras facing forwards until the phone re-localizes and displays 3D representations of mechanical and electrical equipment in accordance with the user's location. In one embodiment, the mechanical and electrical equipment may be displayed as schematics or box diagrams that are superimposed upon a real-time image from the camera of the user computing device.

In a user computing device that is not capable of area learning, in an alternative to steps 1313-1319, at step 1312, the user computing device may be pointed at the nearest fixed anchor image to re-localize the user computing device to fixed anchor image and to display the mechanical and electrical services in the ceiling in augmented reality.

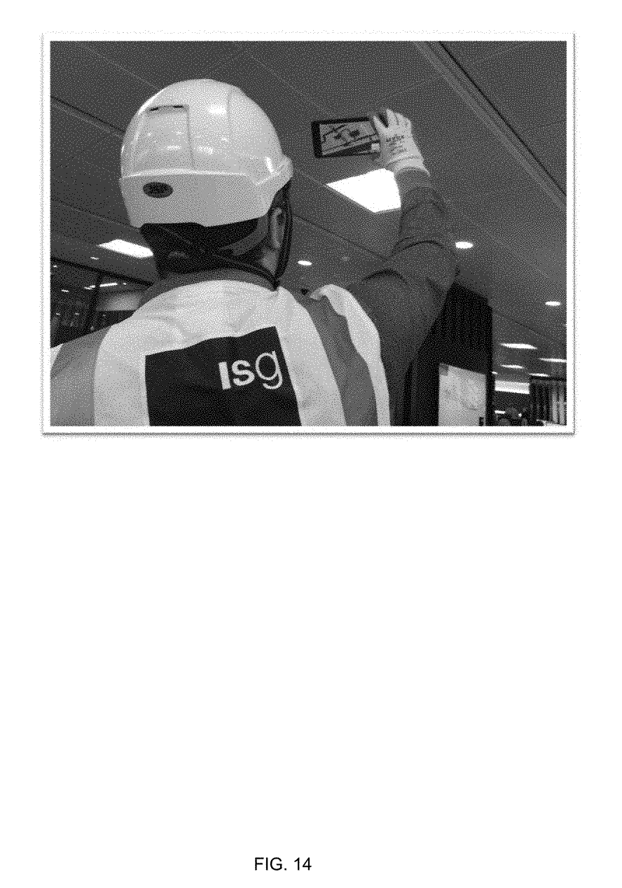

Examples related to FIG. 13A are illustrated in FIGS. 14-24.

FIG. 13B illustrates a process that updates an augmented reality model remotely. The process illustrated in FIG. 13B may be analogous to the process illustrated in FIG. 5B. At step 1321, a user may export a new 3D model from a 3D modeling program as an Filmbox® format (.fbx) or any other suitable format for importation into a software engine such as the Unity® software application or the like. In a second step 1323, the user may open the previously saved project and reimport the new 3D model. In a third step 1325, the user may recompile the software asset bundle. In a fourth step 1327, the revised application may be uploaded to the online repository so that it is accessible for download by other user devices in the event that it was updated. In a fifth step 1329, the augmented reality software asset bundle may be uploaded to the online repository so that it is accessible for download by other user devices in the event that it was updated. In a fifth step 1331, a user may download the updated application and the revised asset bundles containing the new 3D model onto a user computing device.

In one embodiment, augmented reality software application asset bundles may be downloaded and launched at runtime. In this manner, modifications, revisions, or updates to the 3D model can be performed without requiring an application on the user device to be recompiled or reinstalled. Augmented reality software application bundles may allow content and geometry information to be separated from other aspects of the software application.

FIG. 13C illustrates a process that updates an augmented reality model using an USB cable. At step 1333 an user may export a new 3D model from a 3D modeling program. Example formats for the 3D model may include (without limitation) a Filmbox® format (.fbx) or any other suitable format for importation into a game engine or augmented reality software creation program (e.g., Unity® software application) or the like. At step 1335 a previously saved project may be opened and reimport the new 3D model. At step 1337 the application may be compiled and installed on a user computing device with the click of a button.

In an alternative embodiment, an graphical object file such as an object file (e.g., .OBJ format) may be programmatically generated, uploaded to a data sharing platform such as Google® Flux® and used to dynamically update the 3D model on the user computing device without having to use the game engine software creation program (e.g., Unity® software asset packages).

FIG. 13D illustrates a process that updates the augmented reality model remotely using a data sharing platform and without a game engine software creation program. At step 1339 the user may make changes to the 3D model using building information modeling software (e.g., Revit®). At step 1341 the changes to the 3D model may be synchronized by way of a building data sharing platform application interface. At step 1343 the user may download a structured representation of the 3D model from the building data sharing platform. In one non-limiting example a JSON representation of the model from a dating sharing platform may be downloaded to a 3D software or gaming application such as Unity® software. At step 1345 the system may programmatically interpret the geometric shapes defined in the structured representation of the 3D model and dynamically generate and/or recreate the geometric shapes in the augmented reality application. In one non-limiting example, a user may utilize the data in a Flux® JSON file and dynamically generate the geometric shapes in the Unity® software application by recreating the individual shapes. At step 1347 the dynamically generated 3D model may be viewed in augmented reality. At step 1349 the output from the generated geometric shapes may be programmatically sliced and flattened into a 2D floor plan. At step 1351 the 2D floor plan may be viewed in augmented reality.

FIG. 13E illustrates a process for updating the augmented reality model remotely. In a non-limiting example, this may involve using a self-generated JSON file. As illustrated in FIG. 13E, at step 1353 a user may make changes to the model in a building information modeling software (e.g., Revit®). At step 1355 a user may click on an application interface to generate a structured representation of the 3D model (e.g., JSON file). At step 1357 a customized building information modeling software application interface add-in may be used to upload the structured representation of the 3D model to a platform agnostic online database. At step 1359 a structured representation of the 3D model may be downloaded from the online database into an augmented reality application. At step 1361 geometric shapes defined in the structured representation of the 3D model may be programmatically interpreted and used to dynamically generate the geometric shapes by recreating the individual shapes. At step 1363 the generated geometric shapes may be used to view the 3D model in augmented reality. At step 1365 the generated geometric shapes may be programmatically sliced and flattened so that the 2D floor plan may be viewed in augmented reality at step 1367.

In one non-limiting example, in accordance with the process illustrated in FIG. 13E, a bespoke Revit® API add-in may be used to generate a JavaScript® Object Notation (JSON) file that is directly uploaded to a server, downloading it on the augmented reality app and programmatically regenerating graphics on the augmented reality app by interpreting the description of the items in the JSON file. The reproduction process may involve generating polylines, surfaces, faces, and basic 3D components to recreate an approximation of the building information management data.

FIG. 13F illustrates an alternative embodiment where an augmented reality model may be updated remotely. As illustrated in FIG. 13F, edits may be made to a 3D model in a building information modeling software (e.g., Revit®) at step 1369. At step 1371, a representation of the 3D model may be saved in a geometry definition file using a customized building information modeling software application interface. In a non-limiting example, a bespoke Revit® API add-in may be used to save the 3D model in the OBJ format. At step 1373 the geometry definition file may be uploaded to an online repository. At step 1377 the 3D model loaded from the geometry definition file may be displayed in the augmented reality application with the aid of custom scripting. At step 1381 the 3D model can be sliced and flattened into a 2D view in real time to represent a 2D floor plan that is a true reflection of the updated 3D model. The 2D model may be viewed at step 1383. Alternatively, at step 1379 the 3D model may be viewed in augmented reality.

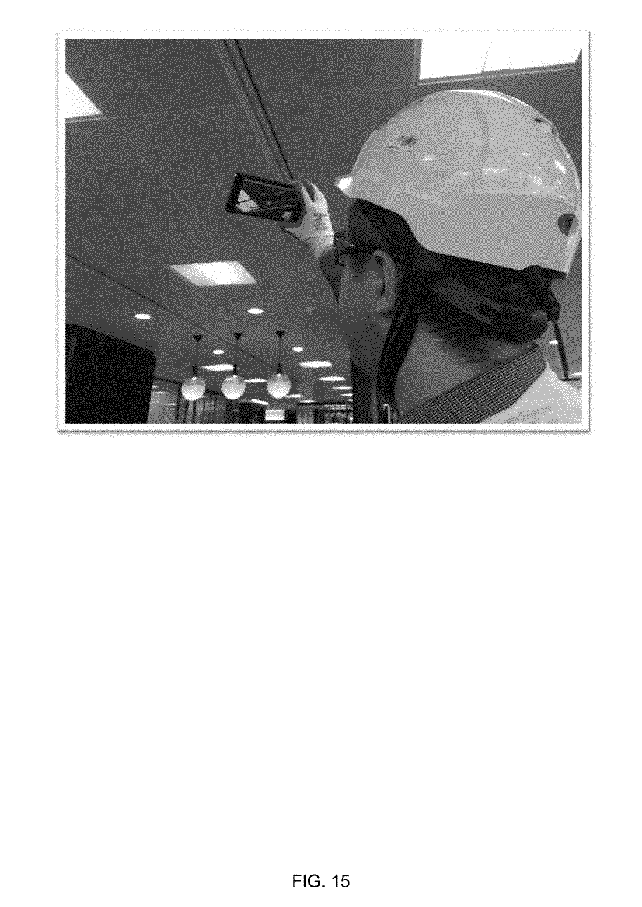

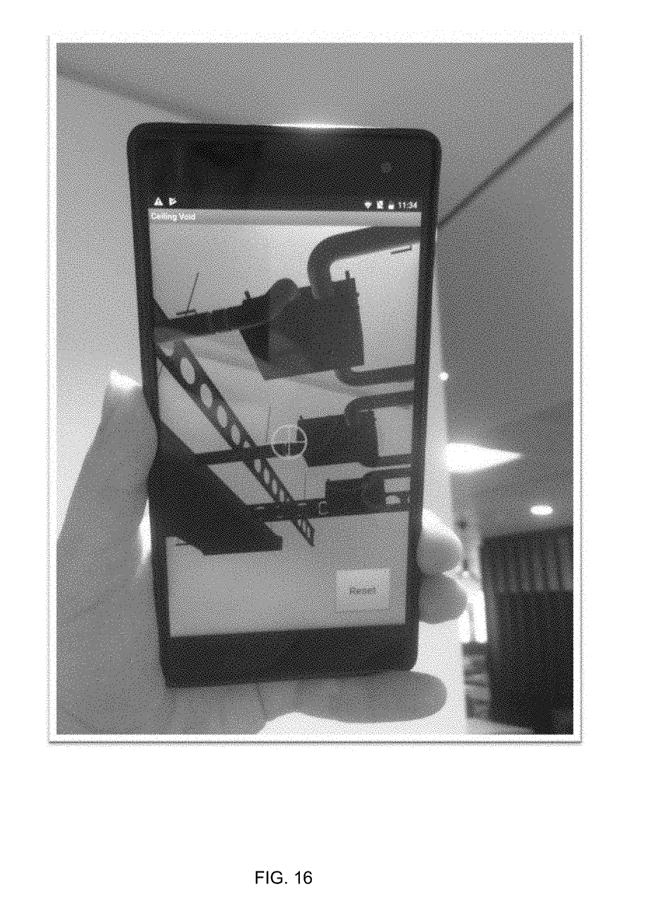

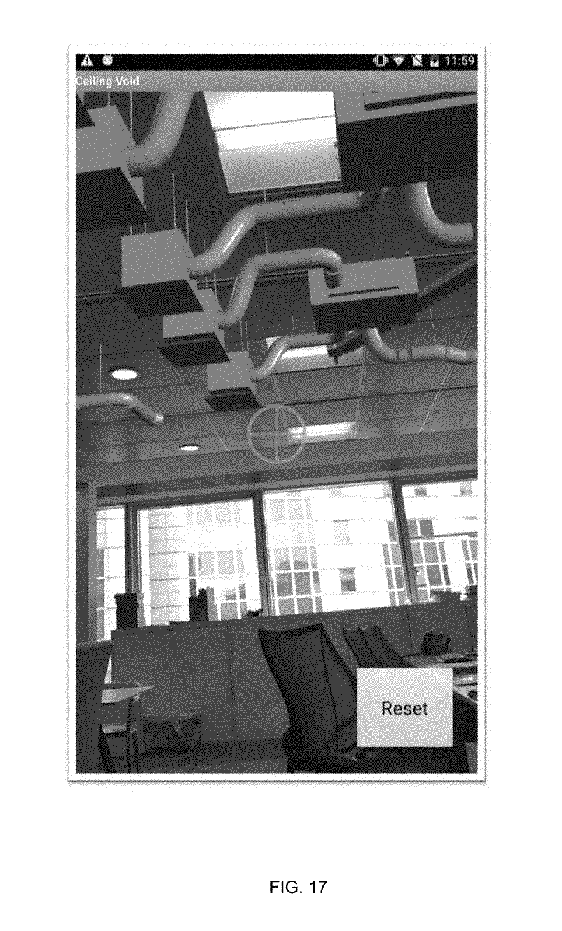

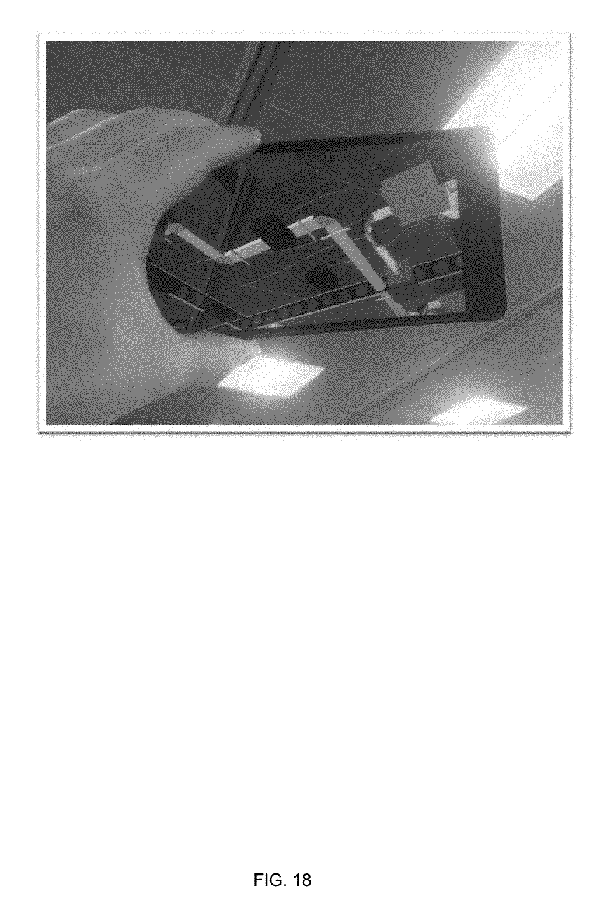

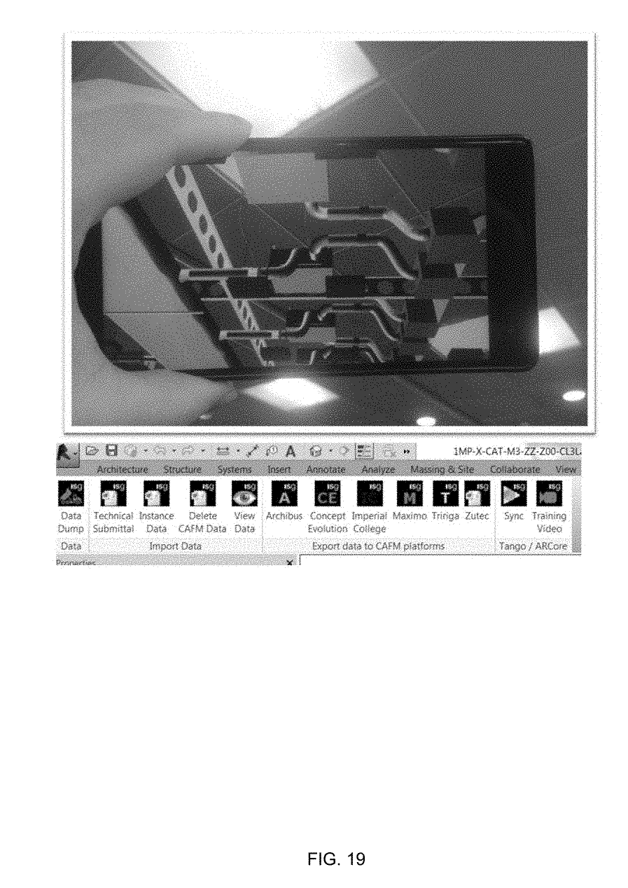

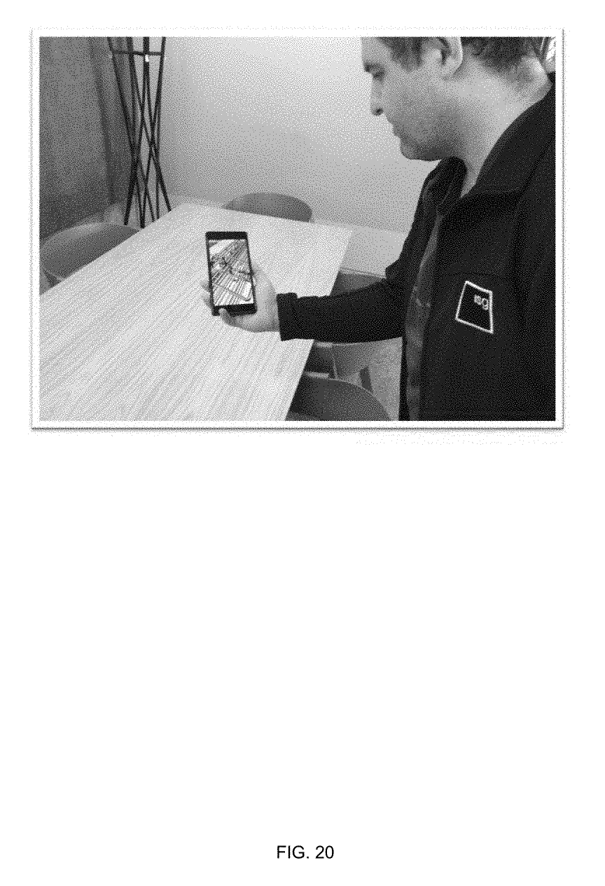

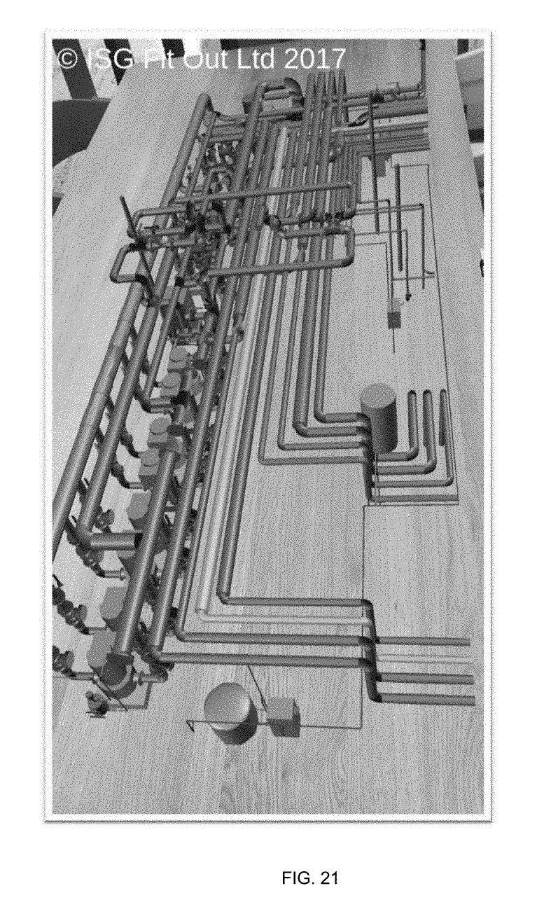

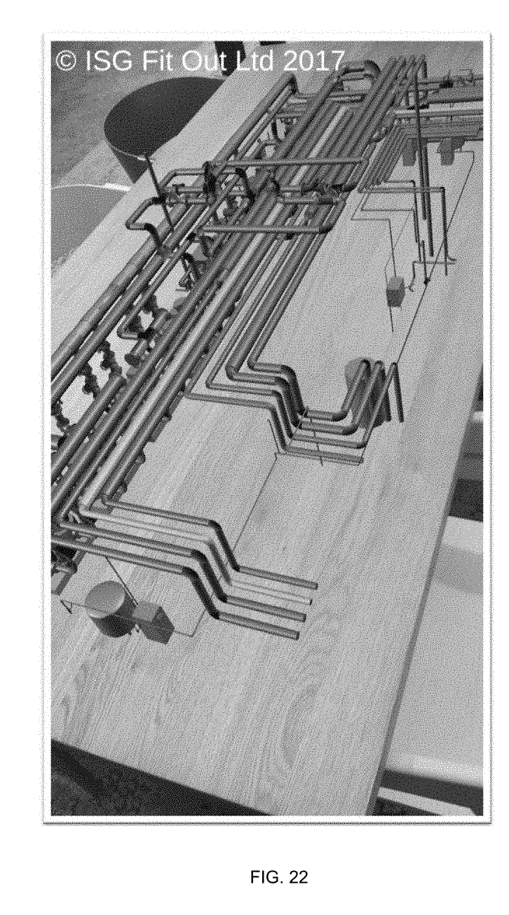

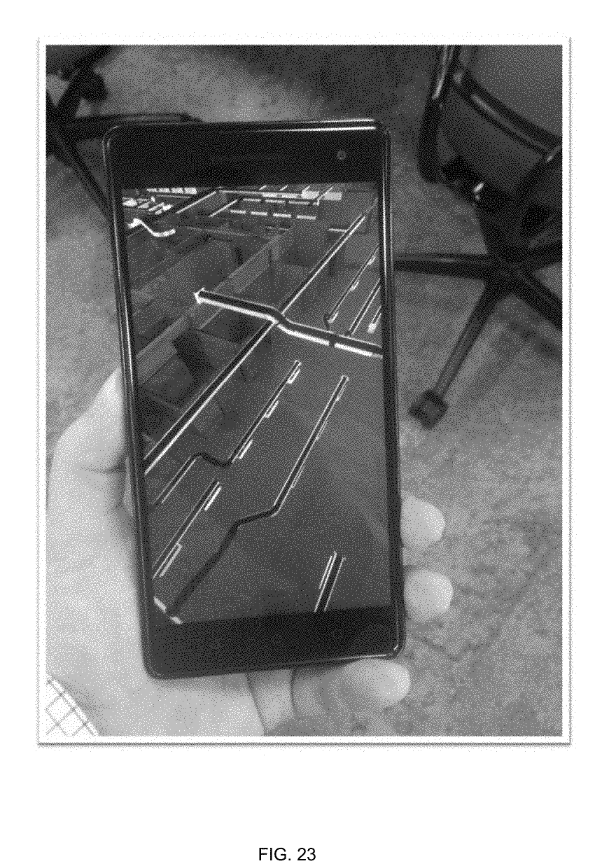

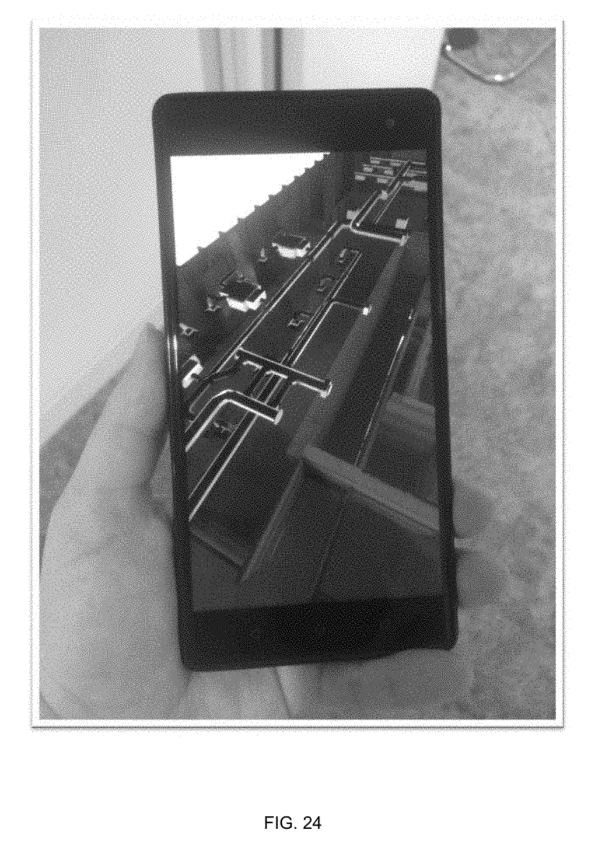

FIGS. 14-24 illustrate augmented data in the form of mechanical and electrical equipment that is superimposed upon a real-time image from the camera of the user computing device in accordance with the processes illustrated in FIGS. 13A-13F. In particular, FIG. 14 illustrates a user pointing a user device towards the ceiling in a first location and viewing air duct information. In particular, FIG. 15 illustrates a user pointing a user device towards the ceiling in a second location and viewing air duct information. In particular, FIG. 16 illustrates a user pointing a user device towards the ceiling in a third location and viewing air duct information. In particular, FIG. 17 illustrates a user pointing a user device towards the ceiling in a fourth location and viewing air duct information. In particular, FIG. 18 illustrates a user pointing a user device towards the ceiling in a fifth location and viewing air duct information. FIG. 19 illustrates a user pointing a user device towards the ceiling in a sixth location and viewing air duct information. FIGS. 20-24 illustrate a user pointing the user device downwards towards the floor and viewing pipe information. FIG. 20 illustrates the pipe configuration within the floor below the table. FIG. 21 illustrates the screen displaying the pipe information. FIG. 22 also illustrates the pipe configuration. FIG. 23 illustrates building information displayed on a user device when the user device is pointed downwards towards the floor. FIG. 24 also illustrates building information displayed on a user device when the user device is pointed downwards towards the floor.

In one embodiment, the 3D model discussed in relation to FIGS. 13A-24 may be exhibited on a display of the user computing device. In particular, a user computing device may include an application that is configured to retrieve a two-dimensional representation of an environment, a server that is communicatively coupled to the user computing device may receive from the first device the two-dimensional representation of an environment, store the two-dimensional representation of the environment on a database, retrieve, from a user device having a display and a camera, one or more images corresponding to the environment, generate a three-dimensional representation of the environment based on the one or more images retrieved from the user device and the two-dimensional representation of the environment, and exhibit on the display of the user device the three-dimensional representation of the environment.

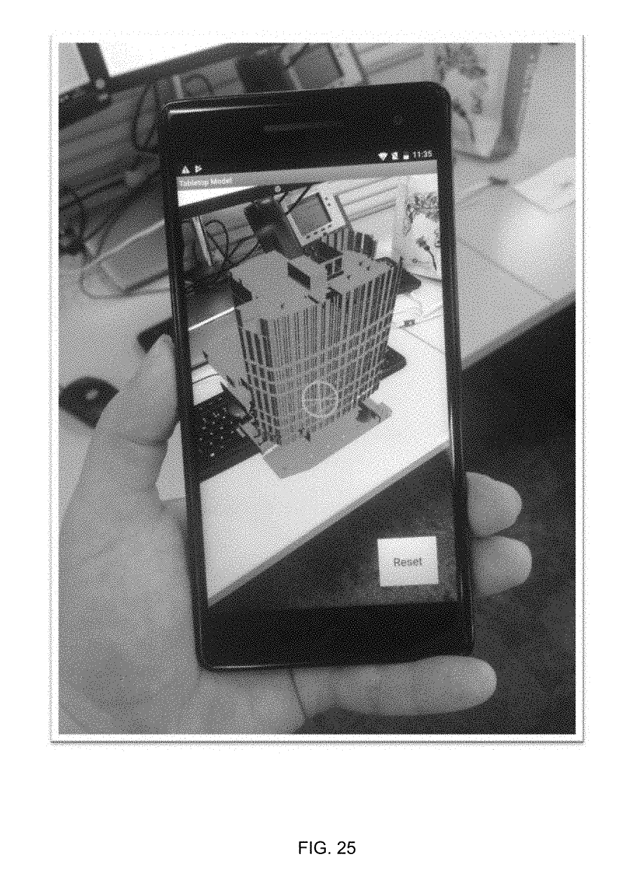

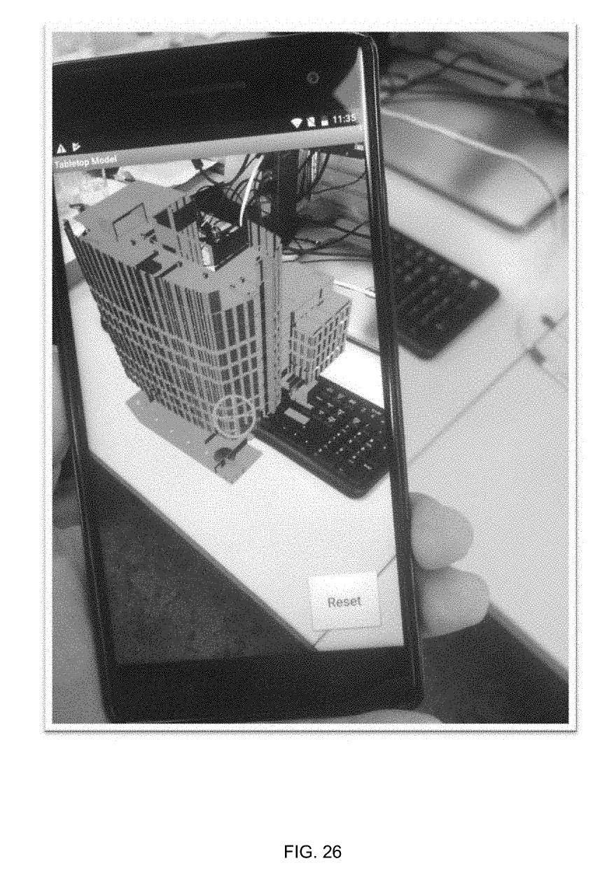

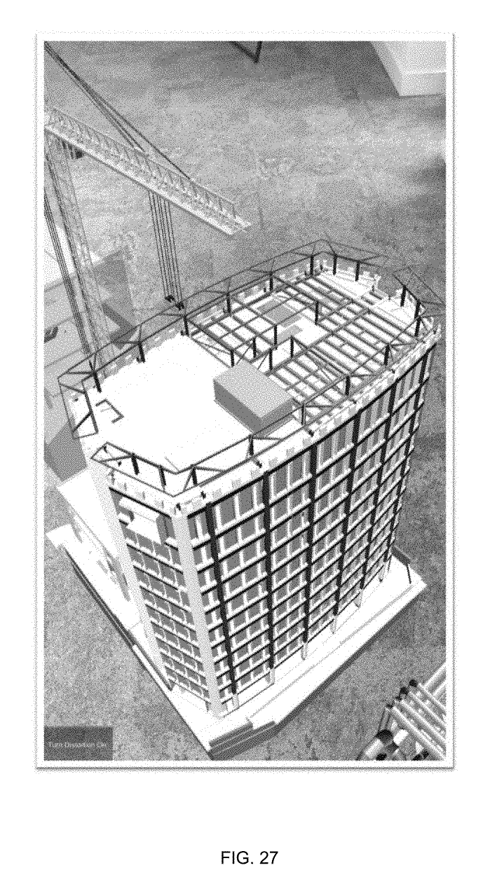

FIGS. 25-27 illustrate the displayed 3D representation of the environment. For example, in FIG. 25 illustrates a 3D building model projected onto an image captured by a camera of the user device. FIG. 26 illustrates a second view of the 3D building model projected onto an image captured by the camera. FIG. 27 illustrates another 3D building model projected onto a floor.

In one embodiment, the spatial and locational awareness of the user computing device 101 discussed in connection with the systems and methods described above, may be used to provide an overlay of one or more snags on a real-time image of an environment. As used herein the term “snag” may refer to a marker that displays notes related to the object associated with the snag. Items that may be snagged may include incorrectly selected, installed or commissioned equipment, incorrectly constructed building element, incorrect or misplaced materials, non-compliant equipment, equipment or materials with substandard workmanship or quality, damaged items, regulatory non-compliant equipment (e.g., non-compliant due to sustainability, continuous diagnostics and mitigation non-compliant, gas, wiring regulations etc.) and equipment faults, breakdowns and other maintenance issues. The snag may be linked to the positional information for an object in the image obtained by the camera of the user device.

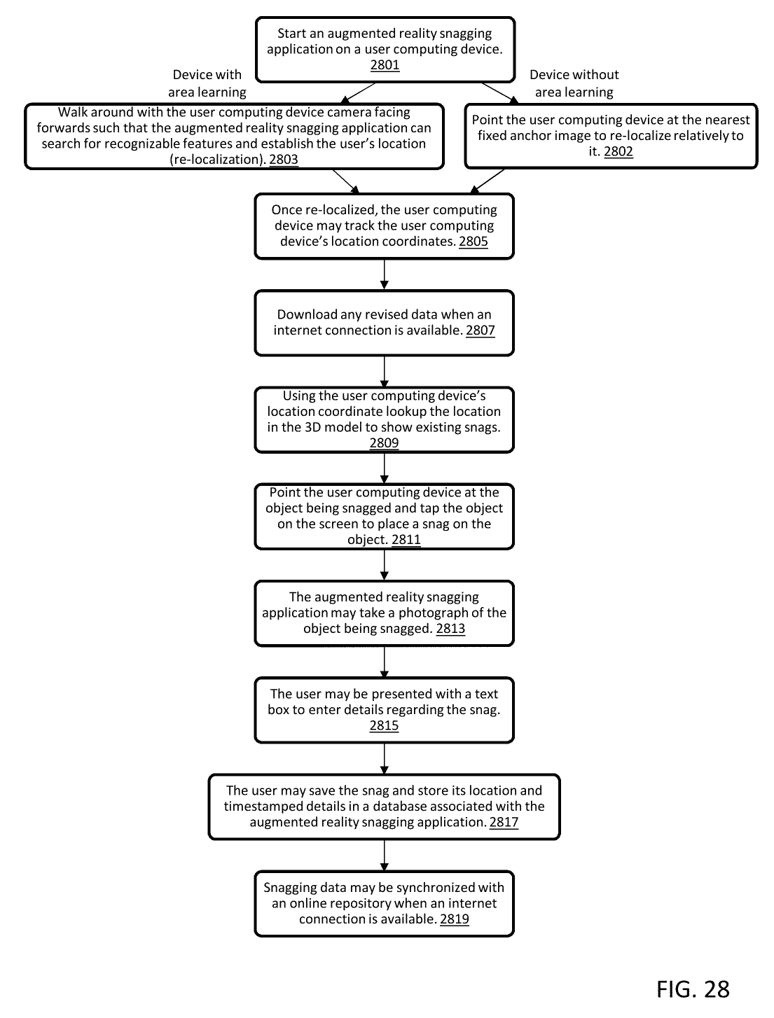

A process for adding a snag into the augmented reality environment is illustrated in FIG. 28. The process may be similar to the process described above with respect to the operation and maintenance manual described above. At step 2801 a user may start the snagging application on a user computing device. In a user computing device capable of area learning, at step 2803 a user may re-localize the user computing device in accordance with the methods discussed above. Alternatively, in a user computing device not capable of area learning, at step 2802, the user computing device may be pointed at the nearest fixed anchor image to re-localize the user computing device with respect to the anchor image. At step 2805 the user computing device is able to determine its position within the environment based on information from the position information sensor. At step 2807 the user computing device may download any revised data from a cloud server when a network or internet connection is available. At step 2809 the user computer device may generate positional information identifying the location of the user computing device within the environment from the positional information sensor. The user computing device may then look up the same location in the 3D model to show existing snags or marker/notes. At step 2811 the user may point the camera of the user computing device towards the object in the environment the user would like to snag. The user may then tap the image of the object on their display in the user computing device. By tapping the image, the user has indicated the location the snag will be placed in. At step 2813 the application may be configured to use the camera of the user computing device to take a photograph of the object being snagged. At step 2815 the user may be presented with a textbox allowing the user to enter text, notes, images, videos, audio files, and the like. At step 2817, the snag may be stored. The snag may include the user entered information (e.g., text, notes, images, videos, audios files, etc.), location information (from the positional information sensor) and timestamp information. The snag may be stored in the local memory of the user computing device 101. At step 2819, the locally stored snag may be uploaded and synchronized with an online repository of snags (e.g., snag data table 141 of database 107) such that snag data is available across all user computing devices in the same environment.

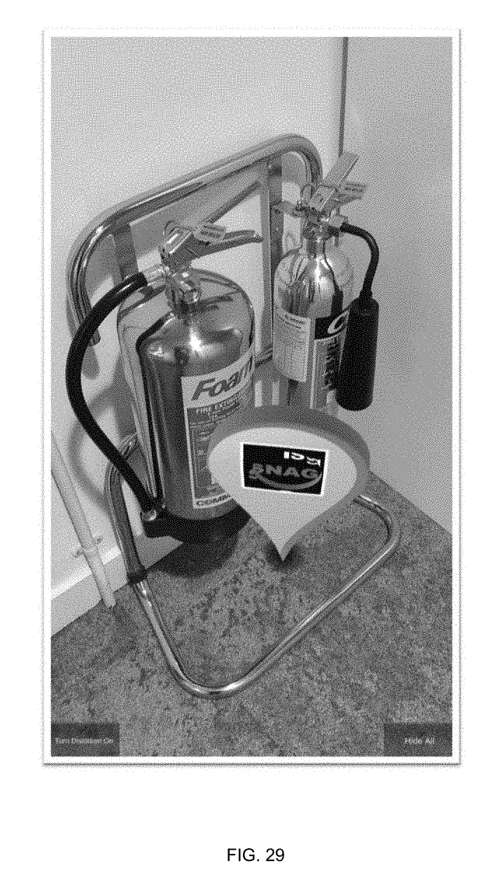

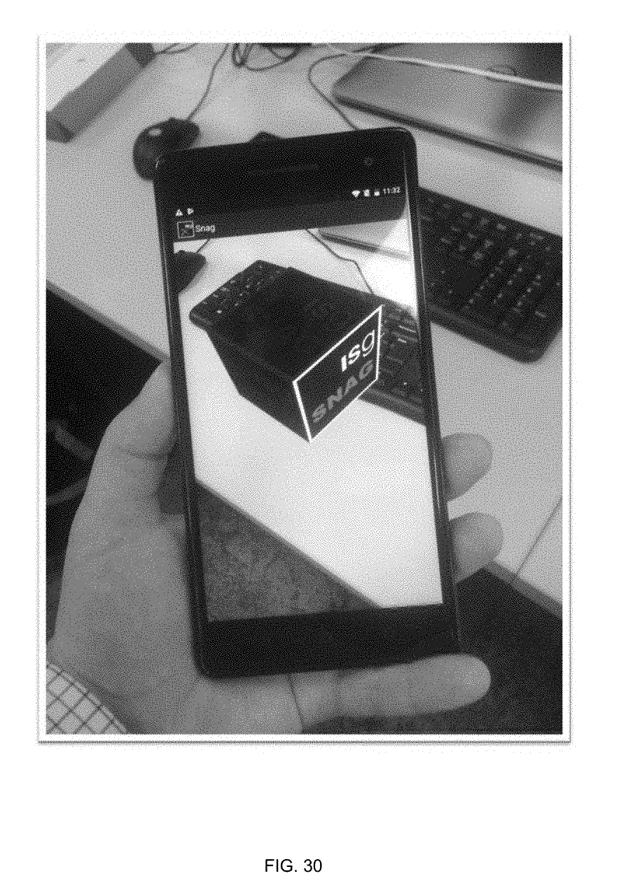

When a user computing device is in proximity of a snag, the snag icon may be displayed in the modified image provided on the display of the user computing device. The user may then click on the snag icon to view the user entered information, timestamp information, and the like. Example snags are illustrated in FIGS. 29 and 30. For example in FIG. 29 a comment snag indicator is used. In FIG. 30 a rectangular snag indicator is illustrated. A single object may have one or more snags. In one embodiment, snags may be cued to x-y-z coordinates corresponding to the area definition file.

In one embodiment, the spatial and locational awareness of the user computing device 101 discussed in connection with the systems and methods described above, may be used to provide an overlay of one or more health and safety hazards on a real-time image of an environment. In one embodiment, the health and safety hazards may provide a graphical indication of a hazard on top of a real-time image. Similar to the snag application, by selecting the displayed hazard the user may view more information regarding the hazard. The hazard may be linked to the positional information for an object in the image obtained by the camera of the user device.

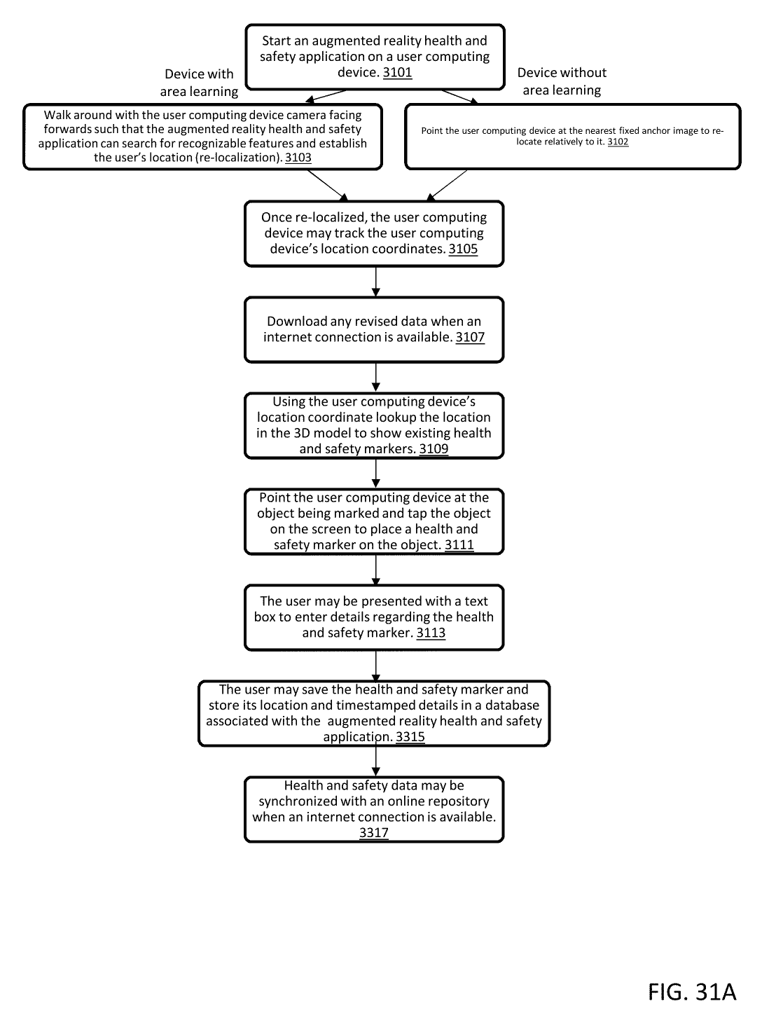

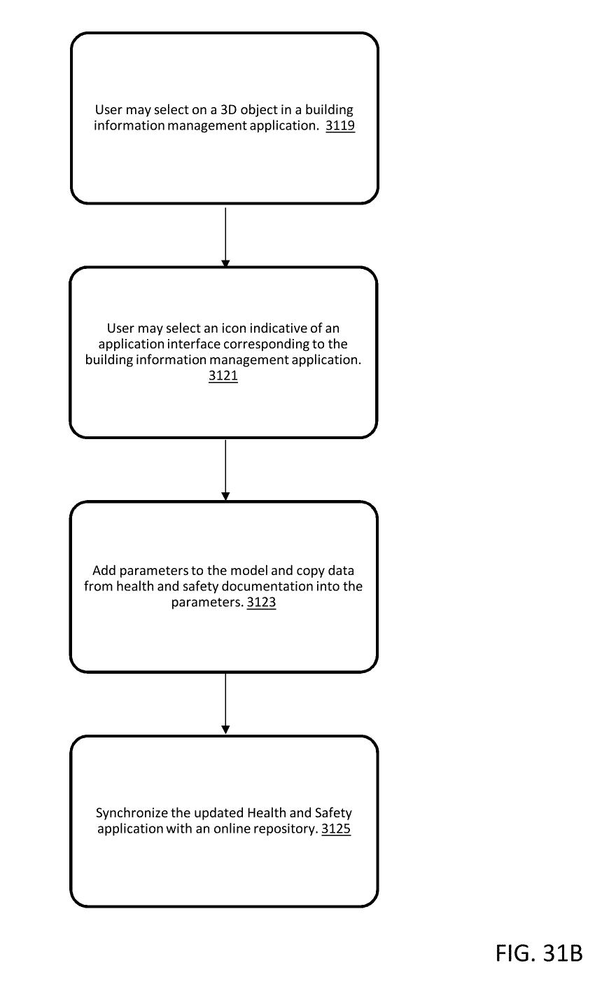

A process for adding a hazard into the augmented reality environment is illustrated in FIG. 31A. The process may be similar to the process described above with respect to the snagging application described above. At step 3101 a user may start the hazard application on a user computing device. At step 3103, if the device is capable of area learning, a user may re-localize the user computing device in accordance with the methods discussed above. In particular, the user may walk around with the user computing device camera facing forwards such that the augmented reality health and safety application can search for recognizable features and establish the user's location (i.e., re-localization). Alternatively, if the device is not capable of area learning, at step 3102, the user may point the user computing device at the nearest fixed anchor image to re-localize the device using the anchor image. At step 3105 the user computing device is able to determine its position within the environment based on information from the position information sensor. At step 3107 the user computing device may download any revised data from a cloud server when a network or internet connection is available. At step 3109 the user computer device may generate positional information identifying the location of the user computing device within the environment from the positional information sensor. The user computing device may then look up the same location in the 3D model to show existing hazards. At step 3111 the user may point the camera of the user computing device towards the object in the environment the user would like to add a hazard indicator for. The user may then tap the image of the object on their display in the user computing device. By tapping the image, the user has indicated the location the hazard will be placed in. At step 3113 the user may be presented with a textbox allowing the user to enter text, notes, images, videos, audio files, and the like regarding the details of the health and safety marker. At step 3115, the hazard may be stored. The hazard may include the user entered information (e.g., text, notes, images, videos, audios files, etc.), location information (from the positional information sensor) and timestamp information. The hazard may be stored in the local memory of the user computing device 101. At step 3117, the locally stored hazard may be uploaded and synchronized with an online repository of hazard (e.g., hazard data table 139 of database 107) such that hazard data is available across all user computing devices in the same environment.

FIG. 31B illustrates how risk assessment and method statements may be added to the health and safety markers (also referred to as hazards) that were added to the model by the process illustrated in FIG. 31A. At step 3119 a user may click on a 3D object within a building information management file (e.g., Revit® file). At step 3121 the user may click on an option that is configured to import information from a structured Risk Assessment and Method Statement template that is stored as a structured Microsoft® Word document with tagged content control fields, or a structured PDF document containing macro-generated, machine-readable metadata as HTML tags embedded in the document's background as invisible white text. At step 3123 data and information from the structured Risk Assessment and Method Statement may be extracted and used to populate hazard information that is displayed as a part of the 3D model.

In one embodiment, the Risk Assessment and Method Statement may include one or more templates that are related to the application add-in for importing data from structured documents into 3D models 153 illustrated in FIG. 1. In one embodiment, the Risk Assessment and Method statement template may include a set of custom buttons on a desktop-based 3D building information modeling program such as Revit® or the like. The Risk Assessment and Method Statement may be configured as a structured Word document template. Once this template is populated by a user using the user computing device 101B, its contents can be programmatically imported into the 3D model. The contents may be programmatically imported into the 3D model by selecting a specific 3D object in the building information modeling program with a mouse, clicking a custom button within the building information modeling program which opens up a file selection dialog, selecting a populated Risk Assessment and Method Statement document, and extracting structured data from the selected Risk Assessment and Method Statement document using a customized building information modeling program application interface in a document field by field manner and recreating the extracted data within the 3D objects as appropriately named data parameters. Once the data from all the Risk Assessment and Method Statement documents has been transferred to their corresponding 3D objects in the 3D model, another customized application interface for the building information modeling program, the application interface add-in for 3D Modeling Software Synchronization 149 illustrated in FIG. 1 may be used. In accordance with the processes illustrated in FIGS. 12A and 12B, the application interface add-in for 3D Modeling Software Synchronization 149 may be used to synchronize the extracted data with the user computing devices 100 providing augmented reality on site.

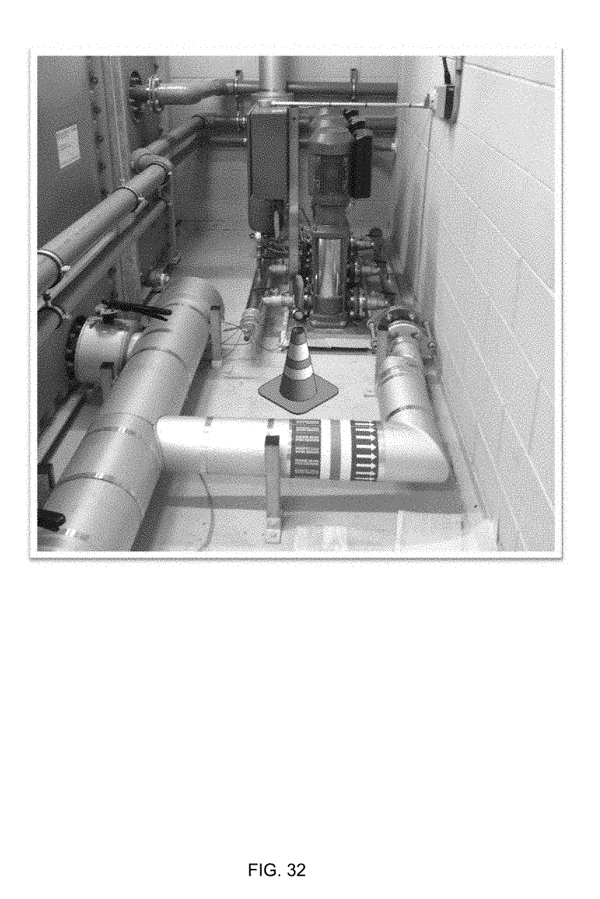

When a user computing device is in proximity of a hazard, the hazard icon may be displayed in the modified image provided on the display of the user computing device. The user may then click on the hazard icon to view the user entered information, timestamp information, and the like. Example hazards are illustrated in FIG. 32.

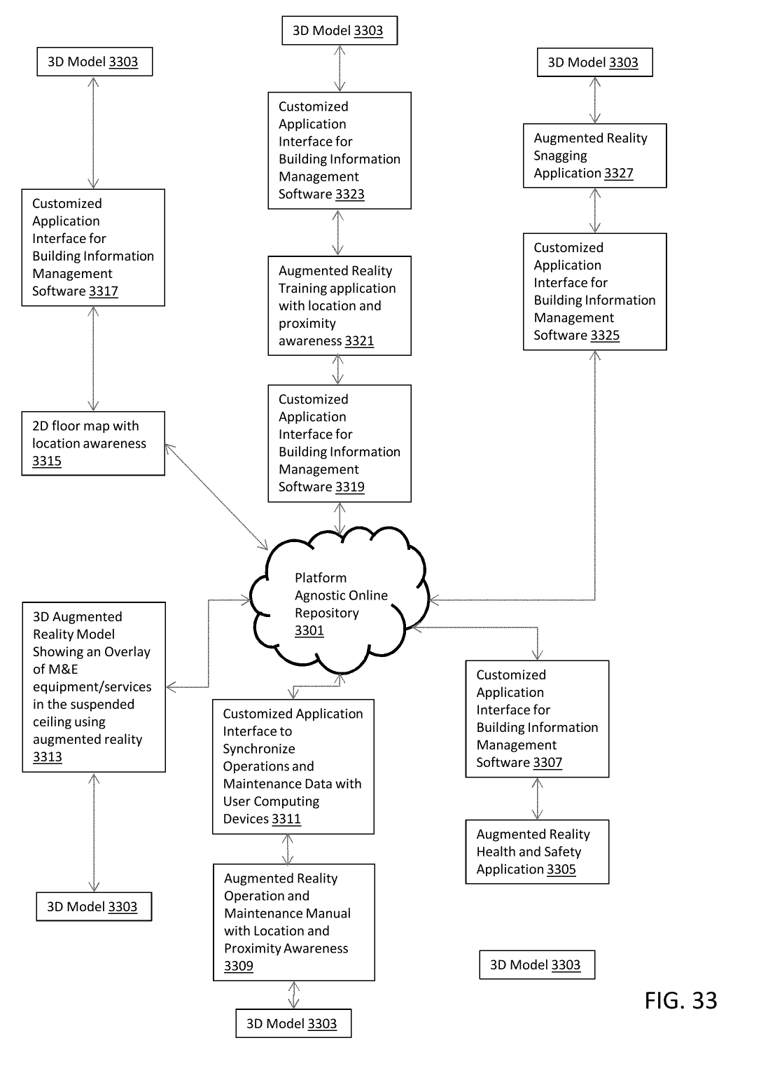

FIG. 33 provides an illustration of a simplified system architecture that may be used in connection with the systems, methods, and processes described herein. As illustrated each of the applications described herein, including the 3D augmented reality model showing an overlay of mechanical and electrical equipment and services in the suspended ceiling, the operation maintenance manual with location and proximity awareness, the health and safety hazards, the snagging, the training, and the 2D floor map with location awareness, may be connected by respective building information modeling software application program interfaces that intermediate between the software applications and a centralized platform. Each of the applications may also interface with the 3D model for the environment. FIG. 33 provides a simplified architectural diagram of the system. In one embodiment, the flowcharts provided herein are an expansion of the individual branches of the flowchart illustrated in FIG. 33.

As illustrated in the embodiment depicted in FIG. 33, a central platform agnostic online repository 3301 may interface with a 3D model 3303 via one or more applications. For example, an application may include a 2D floor map with location awareness 3315 that includes a customized application interface for building information management software 3317 that interfaces with the 3D model 3303. A second example application may include an augmented reality training application with location and proximity awareness 3321 that interfaces with the platform 3301 via a customized application interface for building information management software 3319. The application 3321 may also interface with the 3D model 3303 via a customized application interface for building information management software 3323. A third example application may include an augmented reality snagging application 3327 that interfaces with a 3D model 3303 and the platform agnostic online repository 3301 via a customized application interface for building information management software 3325. A fourth illustrative example application may include an augmented reality health and safety application 3305 that interfaces with the 3D model 3303 and the platform agnostic online repository 3301 via a customized application interface for building information management software 3307. A fifth example application may include an augmented reality operation and maintenance manual with location and proximity awareness 3309 that interfaces with a 3D model 3303 and the platform agnostic online repository 3301 via a customized application interface that is configured to synchronize operations and maintenance data with user computing devices 3311. A sixth example application may include a 3D augmented reality model that shows an overlay of mechanical and equipment data and services in the suspended ceiling using augmented reality 3113 and is also integrated with the platform agnostic online repository 3301 and the 3D model 3303.

In one embodiment, one or more of the applications, processes and/or systems described herein may be integrated into single or multiple applications. For example, the 2D floor map with locational awareness described herein (with relation to FIGS. 4-7) may be integrated into an application also containing the 3D mechanical and electrical display described herein (with relation to FIGS. 13A-24). For example, in one embodiment, the 2D floor map with locational awareness may be displayed on the display of the user computing device when the user computing device is in a first configuration (i.e., pointed downwards) and the 3D overlay of mechanical and electrical equipment may be displayed on the display of the user computing device when the user computing device is in a second configuration (i.e., pointed upwards).

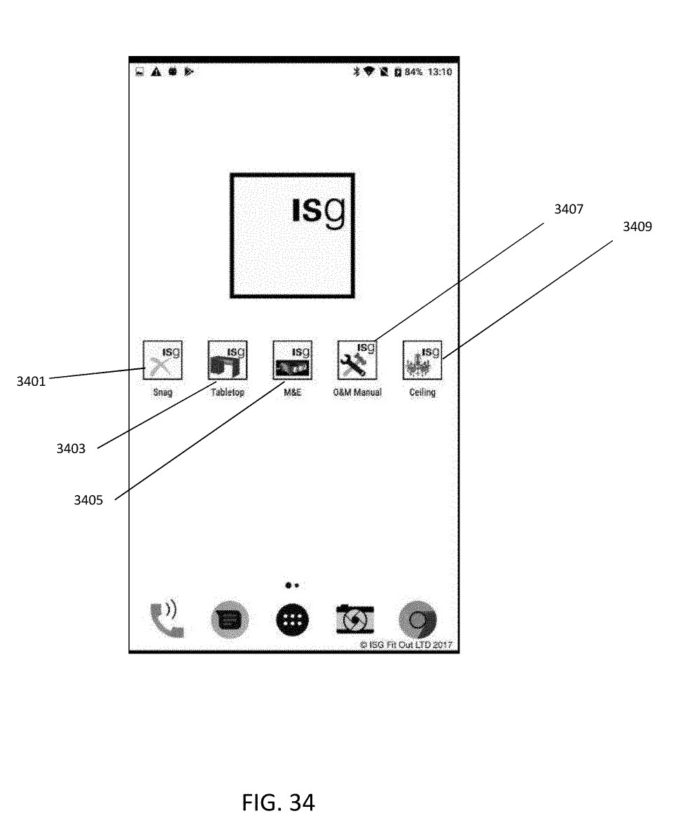

FIG. 34 illustrates the home screen configured to assist a user in navigating between the various applications, processes and/or systems described above. As discussed above, the systems, processes, and methods described herein may provide a snagging application 3401, a tabletop (3D model viewer) application 3403, a mechanical and equipment displaying application 3405, an operation and maintenance manual application 3407, a ceiling displaying application 3409, and the like.

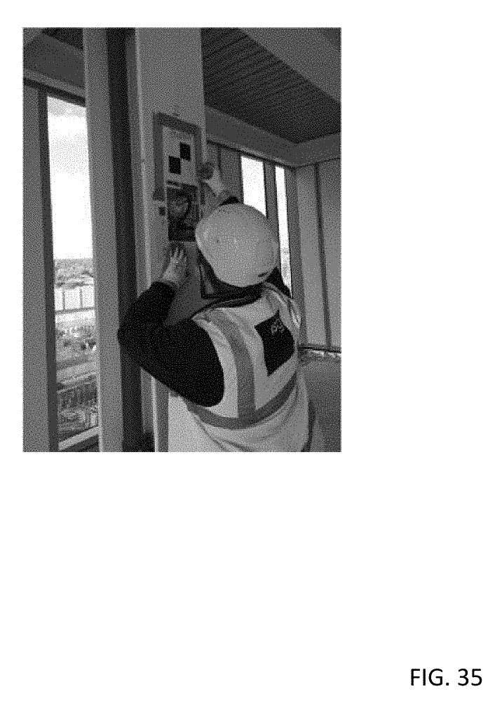

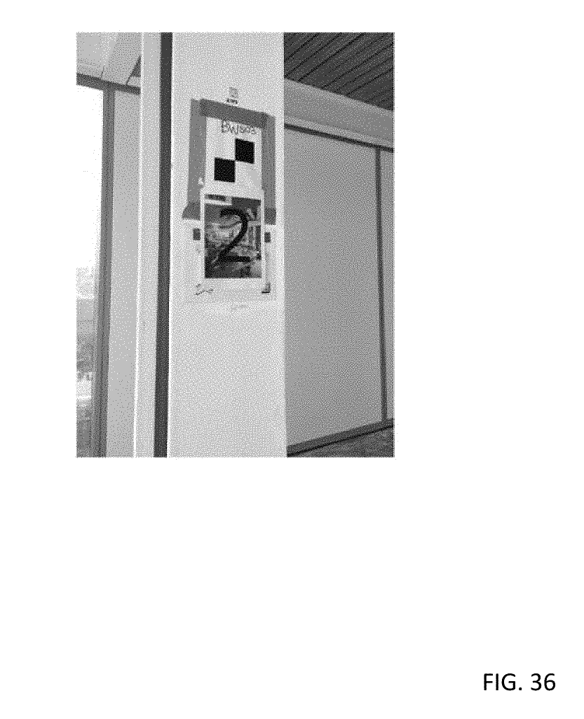

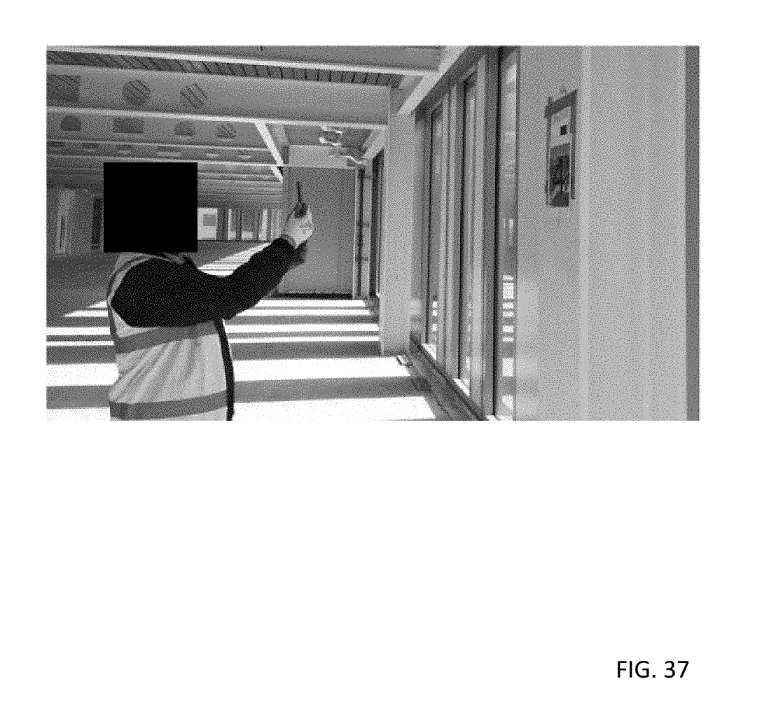

FIGS. 35-37 illustrate an example of a marker for use with an augmented reality system in accordance with an aspect of the present disclosure. In particular, the marker may be positioned on a wall that is visible to the user computing device. Further, the marker may be permanently fixed at a location with known and recorded coordinates. In some embodiments, the marker may be used in connection with a user computing device 101 that is not capable of area learning. In particular, as illustrated in FIG. 35, the marker may be installed on a wall by a user. FIG. 36 illustrates a marker attached to a wall. The marker may include a Quick Response (QR) code, picture, or other distinctly recognizable elements. In some embodiments, the marker may be calibrated with a digital model that is used to help orient objects within an augmented reality system. As illustrated in FIG. 37, the marker may be scanned using a user computing device. The marker may be used in a device without area learning to assist in re-localizing the user computing device to the environment.

In some embodiments, when the marker is scanned, the augmented reality application queries the augmented reality platform (e.g., ARCore® Software Development Kit (SDK)) for the precise position and orientation of the user computing device in relation to the marker, and uses that relational positioning information to dynamically reposition all the 3D geometry in augmented reality in a way that lines up the virtual marker in the 3D model with the physical one. In some embodiments, this is achieved by programmatically anchoring all the 3D geometry to the virtual marker as child elements in the model with the marker being the parent element, and then moving the virtual marker to the position of the physical marker. As the geometry is anchored relative to the virtual marker, it moves along with the marker with relative alignment when the marker is relocated within augmented reality. From that point the relative tracking function of the augmented reality platform may commence tracking the relative physical position and orientation of the user computing device from this known starting point.

When the user scans another marker in a different location, the augmented reality application identifies the marker and assigns all the 3D geometry to that specific marker as child elements and then repeats the process of aligning the virtual marker with the physical one.

In one embodiment the relative tracking from a known starting point can be further enhanced by programmatically tracking the relative positions of ground plane grids that ARCore® can generate. However, unlike with area learning, the non-persistent nature of ground grids in ARCore® would necessitate re-scanning the surrounding environment every time the application restarts.

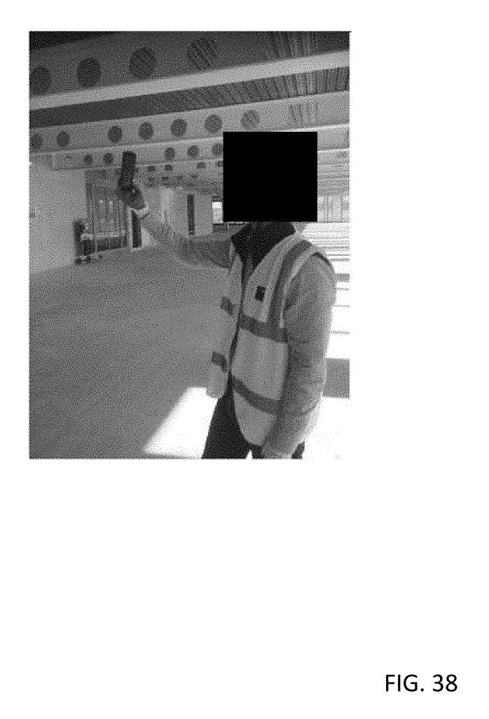

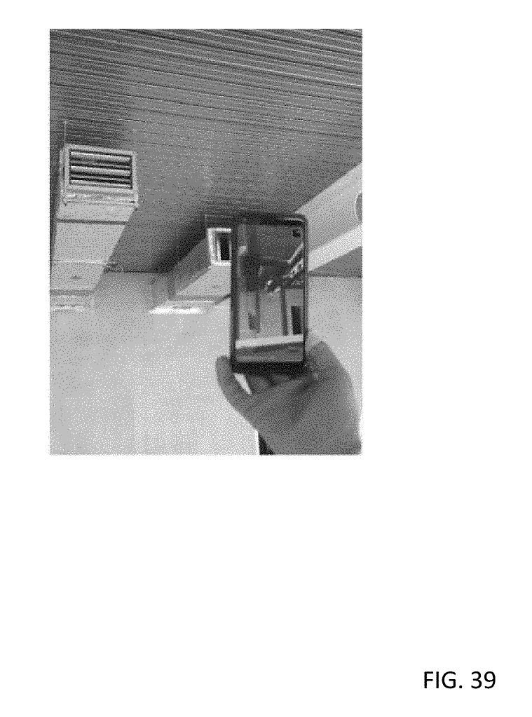

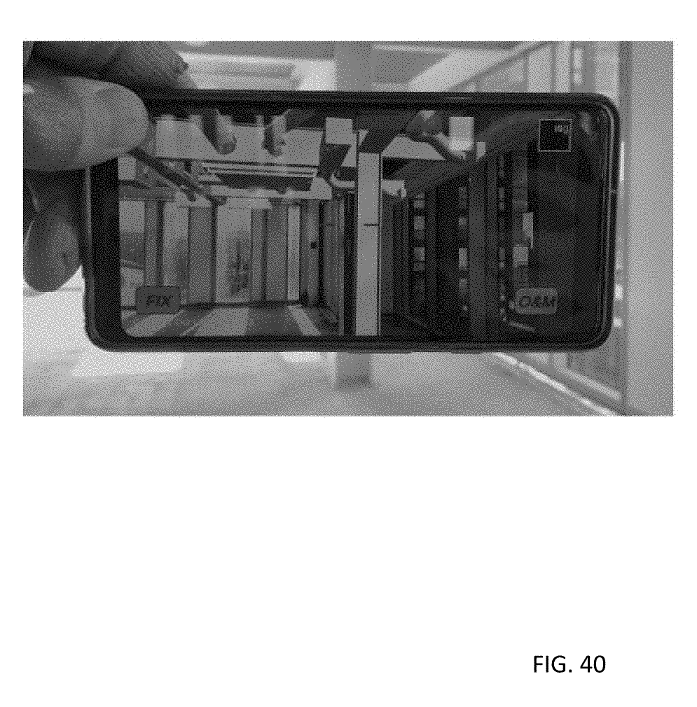

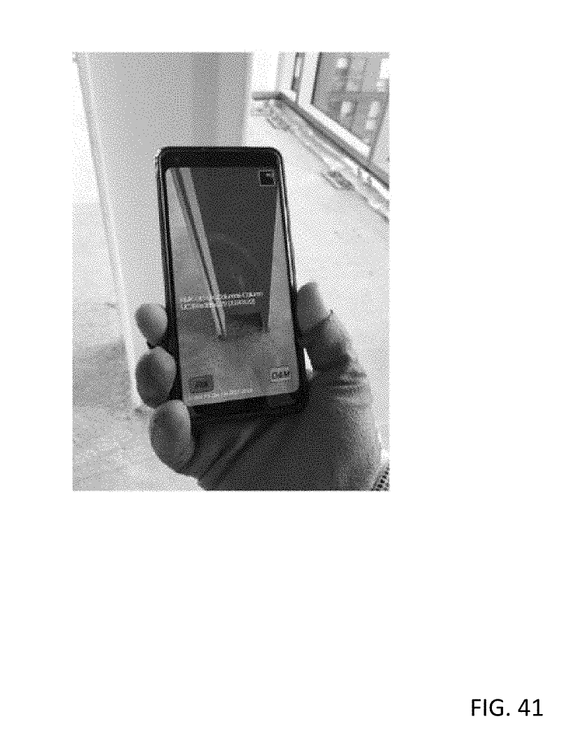

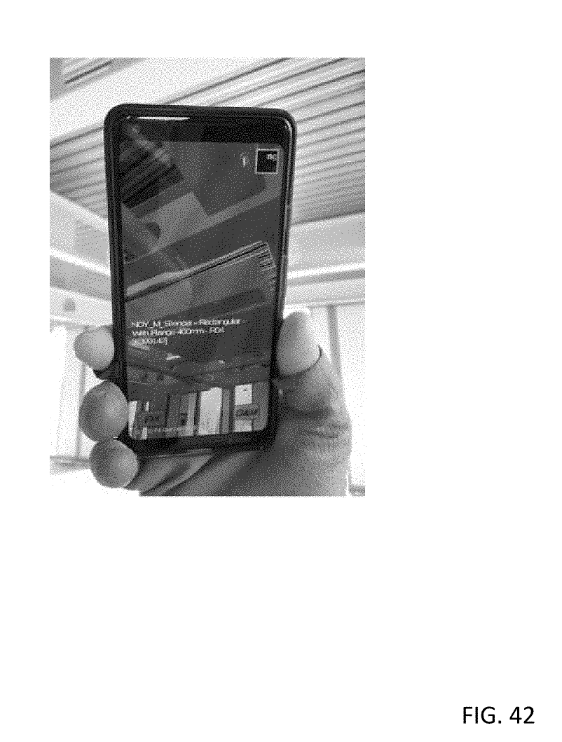

FIGS. 38-42 illustrate an example of usage of the augmented reality system in accordance with an aspect of the present disclosure. As illustrated, a user may hold a user computing device 101 such that the camera can view an air vent, room, panel, etc. and the user may view a representation of the internal contents of the objects. In particular, in FIG. 38, the user points to a ceiling to view the internal components of the objects. As shown in FIG. 39, the user may view schematics of the air vents in the ceiling. Further, as illustrated in FIG. 40, the user may view the building components found within the pillars and structural elements of a room. In particular, in FIG. 41, the user points to a pillar to view the internal components of the pillar. In FIG. 42, the user points to a ceiling to view the internal components of the ceiling.

Although the present disclosure is illustrated in relation to construction and facilities management environments it is envisioned that a system built in accordance with the systems and methods described herein may be utilized in any suitable environment including for example, the shipping industry, oil & gas industry, chemical process industry, mining, manufacturing, warehousing, retail and landscaping etc. It is envisioned that the systems and methods described herein may be used by architects, mechanical engineers, electrical engineers, plumbing engineers, structural engineers, construction professionals, sustainability consultants, health & safety personnel, facilities managers, maintenance technicians, and the like.

Although the disclosure has been described in terms of exemplary embodiments, it is not limited thereto. Rather, the appended claims should be construed broadly to include other variants and embodiments of the disclosure which may be made by those skilled in the art without departing from the scope and range of equivalents of the disclosure. This disclosure is intended to cover any adaptations or variations of the embodiments discussed herein.

1. A system comprising:
a processor;
a user interface coupled to the processor and including a display;
a positional information sensor coupled to the processor;
a communication module coupled to the processor;
a digital camera coupled to the processor; and
non-transitory memory coupled to the processor and storing instructions that, when executed by the processor, cause the system to:
generate an image via the digital camera;
retrieve positional information corresponding to the generated image from the positional information sensor;
retrieve augmented data associated with an object depicted in the generated image based on the retrieved positional information;
modify the generated image to represent the augmented data within the image;
transmit the modified image, using the communication module, to at least one server; and
cause the system to present one of the generated image and the modified image using the display.

2. The system of claim 1, wherein the augmented data is at least one of operational data, schematic data, training data, and maintenance data.

3. The system of claim 2, wherein the training data comprises one of instructions for operating the object depicted in the generated image and electronic links to electronic training videos for the object depicted in the generated image.

4. The system of claim 1, wherein the augmented data corresponds to a hazard or a snag.

5. The system of claim 1, wherein the non-transitory memory coupled to the processor further stores instructions that, when executed by the processor, cause the system to:
exhibit on the display of the user interface, an application configured to receive object information and positional information for an object;
generate augmented data associated with the object in accordance with the received object information and received positional information; and
store the augmented data on a database communicatively coupled to the at least one server.

6. A system comprising:
a processor;
a user interface coupled to the processor and including a display;
a positional information sensor coupled to the processor;
a communication module coupled to the processor; and
non-transitory memory coupled to the processor and storing instructions that, when executed by the processor, cause the system to:
retrieve a multi-dimensional representation of an environment;
retrieve positional information from the positional information sensor;
modify the multi-dimensional representation of the environment with the positional information;
transmit the modified multi-dimensional representation of the environment, using the communication module, to a server; and
cause the system to present one or more generated images including the modified multi-dimensional representation of the environment using the display.

7. The system of claim 6, wherein the multi-dimensional representation is one of a two-dimensional representation and a three-dimensional representation.

8. The system of claim 6, wherein the processor causes the system to:
modify the modified multi-dimensional representation of the environment with augmented data.

9. The system of claim 8, wherein the augmented data is at least one of operational data, schematic data, training data, and maintenance data.

10. The system of claim 9, wherein the training data comprises one or more of instructions for operating the object depicted in the generated image and electronic links to electronic training videos for the object depicted in the generated image.

11. The system of claim 8, wherein the augmented data corresponds to a hazard or a snag.

12. A method comprising:
obtaining an image of an environment;
retrieving positional information corresponding to the generated image from a positional information sensor of a user computing device located within the environment;
retrieving augmented data associated with an objected depicted in the generated image based on the retrieved positional information;
modifying the generated image to represent the augmented data within the image; and
transmitting the modified image to a server configured to display, on the user computing device, the modified image.

13. The method of claim 12, wherein obtaining an image of the environment comprises generating an image via a digital camera of a user computing device.

14. The method of claim 12, wherein obtaining an image of the environment comprises retrieving a multi-dimensional representation of the environment.

15. The method of claim 12, wherein the augmented data one of operational data, schematic data, training data, and maintenance data.

16. The method of claim 12, wherein the training data comprises one of instructions for operating the object depicted in the generated image and electronic links to electronic training videos for the object depicted in the generated image.

17. The method of claim 12, wherein the augmented data corresponds to a hazard or a snag.

18. The method of claim 12 comprising:
exhibit on the display of a user interface of the user computing device, an application configured to receive object information and positional information for an object.

19. The method of claim 18, comprising:
generating augmented data associated with the object in accordance with the received object information and received positional information; and
storing the augmented data on a database communicatively coupled to the server.

20. The method of claim 18, wherein retrieving positional information comprises:
obtaining an image of a marker within the environment; and
determining the position of the user computing device in relation to the position of the marker within the environment, wherein the position of the marker within the environment is stored in a digital model of the environment.
